(19) United States
(12) Patent Application Publication
(10) Pub. No.: US 2008/0267590 A1
(43) Pub. Date: Oct. 30, 2008

(54) Data processing device, data processing method, and program

(75) Inventor: Masahiro Otsuka, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/150,087

(22) Filed: Apr. 24, 2008

(30) Foreign Application Priority Data
Apr. 27, 2007 (JP) P2007-119096

(51) Int. Cl. H04N 7/015

(52) U.S. Cl. 386/123; 386/E05.003

(57) ABSTRACT

In the present invention, there is provided a data processing device that processes a bit stream including at least first data and second data, the device including: a buffer size setting unit configured to set, of a first buffer size of a first buffer and a second buffer size of a second buffer, the first buffer size based on information included in the bit stream, the first buffer temporarily storing the first data and supplying the first data to a first decoder, the second buffer temporarily storing the second data and supplying the second data to a second decoder; and a buffer controller configured to control a buffer size of the first buffer to the first buffer size.

### CROSS REFERENCES TO RELATED APPLICATIONS

The present invention contains subject matter related to Japanese Patent Application JP 2007-119096 filed in the Japan Patent Office on Apr. 27, 2007, the entire contents of which being incorporated herein by reference.

### BACKGROUND OF THE INVENTION

1. Field of the Invention

The present invention relates to data processing devices, data processing methods, and programs, and particularly to a data processing device, a data processing method, and a program that allow reduction in the cost of a device such as a television receiver (TV).

2. Description of Related Art

FIG. 1 is a block diagram showing the configuration of one example of a related-art TV.

To an external input 11, e.g. a transport stream (TS) as an MPEG (Moving Picture Experts Group) stream compliant with the MPEG standard, transmitted by e.g. terrestrial digital broadcasting, is input. The external input 11 supplies the MPEG stream to a demultiplexer 12.

The demultiplexer 12 separates e.g. an elementary stream (ES) of video data (hereinafter, referred to also as a video stream) and an ES of audio data (hereinafter, referred to also as an audio stream) from the MPEG stream from the external input 11, and supplies these streams to a memory 13.

The video and audio streams from the demultiplexer 12 are temporarily stored (buffered) in the memory 13, followed by being supplied to a decoder 14 therefrom.

Specifically, in order to adjust the data amounts of the video and audio streams that are to be supplied to the decoder 14 at the subsequent stage, the memory 13 temporarily stores the video and audio streams supplied from the demultiplexer 12, and then supplies these streams to the decoder 14.

The decoder 14 decodes the video stream from the memory 13 by e.g. a system compliant with the MPEG standard, and supplies the resulting baseband video data to an external output 15. Furthermore, the decoder 14 decodes the audio stream from the memory 13, and supplies the resulting baseband audio data to the external output 15.

The external output 15 supplies the video data from the decoder 14 to a display (not shown), so that the corresponding picture is displayed thereon. In addition, the external output 15 supplies the audio data from the decoder 14 to a speaker (not shown), so that the corresponding audio (sound) is output therefrom.

FIG. 2 is a block diagram showing a configuration example of the memory 13 and the decoder 14 of FIG. 1.

The memory 13 includes a video buffer 13V and an audio buffer 13A.

A video stream is supplied to the video buffer 13V from the demultiplexer 12. The video stream from the demultiplexer 12 is temporarily stored in the video buffer 13V, followed by being supplied to the decoder 14. The video buffer 13V is equivalent to a so-called video buffering verifier (VBV) buffer.

An audio stream is supplied to the audio buffer 13A from the demultiplexer 12. The audio stream from the demultiplexer 12 is temporarily stored in the audio buffer 13A, followed by being supplied to the decoder 14.

The decoder 14 includes a video decoder 14V and an audio decoder 14A.

To the video decoder 14V, a video stream is supplied from the video buffer 13V. The video decoder 14V decodes the video stream from the video buffer 13V, and outputs the resulting video data.

To the audio decoder 14A, an audio stream is supplied from the audio buffer 13A. The audio decoder 14A decodes the audio stream from the audio buffer 13A, and outputs the resulting audio data.

In general, a TV often displays, besides content transmitted by terrestrial digital broadcasting or the like, video of content input from external apparatus such as a reproducing device that reproduces content from a recording medium in which the content is recorded.

Examples of the content input from external apparatus include content of video having a so-called standard definition (SD) picture quality (hereinafter, referred to as SD video) such as content recorded in a digital versatile disc (DVD) (DVD content) and content that is obtained by a digital camera (still camera, video camera) and is compliant with the MPEG1 or the like.

Meanwhile, in recent years, the following products are becoming widespread: a digital camera that allows imaging of video having a high definition (HD) picture quality (hereinafter, referred to as HD video), a recording device that can record content of HD video as a digital broadcast program, and a medium in which content of HD video can be recorded, such as a Blu-ray disc.

Moreover, it is expected that an editing tool that can treat content of HD video will come into existence due to enhancement in functions of a personal computer (PC) and content including mixture of SD video and HD video will be created through editing.

Therefore, it is expected that there will arise a need for a TV to treat, besides content of SD video (hereinafter, referred to as SD content), content of HD video (hereinafter, referred to as HD content) and content including mixture of SD video and HD video in the future.

Japanese Patent Laid-open No. 2000-165816 discloses a device that can decode both an MPEG stream of SD video and an MPEG stream of HD video.

### SUMMARY OF THE INVENTION

As a method for allowing a TV to treat all of SD content, HD content, and content formed of mixture of SD content and HD content, i.e., treat both SD content and HD content, a method in which the TV is provided with both a block for processing SD content and a block for processing HD content would be possible.

FIG. 3 shows a configuration example of such a TV.

Referring to FIG. 3, an MPEG stream of SD content or HD content is input to an external input 21. When the input MPEG stream is an MPEG stream of SD content, the external input 21 supplies the MPEG stream to an SD processor 22. When the input MPEG stream is an MPEG stream of HD content, the external input 21 supplies the MPEG stream to an HD processor 23.

The SD processor 22 includes a demultiplexer 32, a memory 33, a decoder 34, and an external output 35, and processes the MPEG stream of SD content from the external input 21.

Specifically, the demultiplexer 32, the memory 33, the decoder 34, and the external output 35 included in the SD processor 22 execute the same processing as that executed by the demultiplexer 12, the memory 13, the decoder 14, and the external output 15 of FIG. 1, respectively, for the MPEG stream of SD content from the external input 21, so that the resulting SD video and the audio associated with the SD video (hereinafter, referred to as SD audio) are output.

The demultiplexer 32, the memory 33, the decoder 34, and the external output 35 have the same configuration as that of the demultiplexer 12, the memory 13, the decoder 14, and the external output 15 of FIG. 1, respectively, and therefore the description thereof is omitted.

The HD processor 23 includes a demultiplexer 42, a memory 43, a decoder 44, and an external output 45, and processes the MPEG stream of HD content from the external input 21.

Specifically, the demultiplexer 42, the memory 43, the decoder 44, and the external output 45 included in the HD processor 23 execute the same processing as that executed by the demultiplexer 12, the memory 13, the decoder 14, and the external output 15 of FIG. 1, respectively, for the MPEG stream of HD content from the external input 21, so that the resulting HD video and the audio associated with the HD video (hereinafter, referred to as HD audio) are output.

The demultiplexer 42, the memory 43, the decoder 44, and the external output 45 have the same configuration as that of the demultiplexer 12, the memory 13, the decoder 14, and the external output 15 of FIG. 1, respectively, and therefore the description thereof is omitted.

If a TV is provided with both the SD processor 22 as the block for processing an MPEG stream of SD content and the HD processor 23 as the block for processing HD content as described above, the cost of the TV is increased. Moreover, the area of the circuit board is increased, which increases the size of the TV. Furthermore, it is expected that an MPEG stream of content formed of mixture of SD content and HD content could not be processed appropriately.

In order to prevent the increase in the cost of a TV and so on, it is desirable that the TV be provided with only one set of the demultiplexer 12, the memory 13, the decoder 14, and the external output 15 as blocks for processing an MPEG stream (hereinafter, referred to as MPEG processing blocks) as shown in FIG. 1.

However, in the case of providing a TV with the demultiplexer 12, the memory 13, the decoder 14, and the external output 15 as one set of MPEG processing blocks for processing both MPEG streams of SD content and HD content, it is necessary that the storage capacity of the memory 13, i.e., the buffer sizes of the video buffer 13V and the audio buffer 13A of FIG. 2, be set high, because SD content and HD content are different in the storage capacity necessary for the memory 13.

With reference to FIGS. 4A and 4B, by taking video (SD video and HD video) as an example, a description will be made below about the buffer sizes of the video buffer 13V, necessary for SD content and HD content, respectively.

Specifically, the leftmost diagrams of FIGS. 4A and 4B show the data amount D_{S} of one picture of SD video and the data amount D_{H} of one picture of HD video.

The data amount D_{H} of HD video is larger than the data amount D_{S} of SD video (the data amount D_{S} of SD video is smaller than the data amount D_{H} of HD video). Therefore, in processing of HD video, the video buffer 13V having a buffer size larger than that for processing of SD video is necessary.

The center diagrams of FIGS. 4A and 4B show the video buffer 13V having a buffer size appropriate for SD video included in SD content.

Specifically, in the center diagrams of FIGS. 4A and 4B, the buffer size of the video buffer 13V appropriate for SD video is a size V_{S} that allows storing of SD video having a necessary and sufficient data amount.

The video buffer 13V having the buffer size V_{S} can store a necessary and sufficient data amount (data amount that is not too large and not too small) of SD video whose one picture has the data amount D_{S}.

However, in the center diagrams of FIGS. 4A and 4B, the buffer size V_{S} is smaller than the data amount D_{H} of one picture of HD video. Therefore, the video buffer 13V having the buffer size V_{S} can not store a necessary and sufficient data amount of HD video.

The rightmost diagrams of FIGS. 4A and 4B show the video buffer 13V having a buffer size appropriate for HD video included in HD content.

Specifically, in the rightmost diagrams of FIGS. 4A and 4B, the buffer size of the video buffer 13V appropriate for HD video is a size V_{H} that allows storing of HD video having a necessary and sufficient data amount, and is larger than the size V_{S}, which allows storing of SD video having a necessary and sufficient data amount.

The video buffer 13V having the buffer size V_{H} can store a necessary and sufficient data amount of HD video whose one picture has the data amount D_{H}.

Furthermore, the video buffer 13V having the buffer size V_{H} can store SD video, whose one picture has a smaller data amount compared with HD video, having a data amount larger than a necessary and sufficient data amount.

As described above, if the buffer size of the video buffer 13V is set to the buffer size V_{S} appropriate for SD video, HD video having a necessary and sufficient data amount cannot be stored, and processing by the decoder 14 would fail in the worst case. Therefore, the buffer size of the video buffer 13V needs to be set to the buffer size V_{H}, which allows storing of a necessary and sufficient data amount of HD video and thus is appropriate for HD video.

Setting the buffer size of the video buffer 13V to the buffer size V_{H} appropriate for HD video allows the decoder 14 to process both SD video and HD video.

However, if the buffer size of the video buffer 13V is set to the buffer size V_{H} appropriate for HD video, the video buffer 13V can store SD video, which has the data amount D_{S} smaller than that of HD video, having a data amount larger than necessary. This leads to the possibility that, if buffer flush of clearing the data stored in e.g. the audio buffer 13A, as one of the video buffer 13V and the audio buffer 13A, is carried out, a silent state in which audio is not output continues for a long time and thus a user feels a sense of discomfort.

With reference to FIGS. 5 to 7, a description will be made below about the continuation of a long silent time due to the buffer flush of the audio buffer 13A.

FIG. 5 schematically shows an example of an MPEG stream.

Referring to FIG. 5, the MPEG stream includes one video stream and a first audio stream and a second audio stream as two kinds of audio streams.

The first audio stream corresponds to e.g. Japanese audio data, and the second audio stream corresponds to e.g. English audio data.

If an MPEG stream includes two kinds of audio streams of the first audio stream and the second audio stream in this manner, a long silent time possibly continues in the following case: when e.g. the first audio stream is being output as one of the first and second audio streams, a user carries out operation to switch the audio output from the currently-output first audio stream to the second audio stream as the other audio stream.

Specifically, FIG. 6 shows a sequence of data storing in the video buffer 13V and the audio buffer 13A that have buffer sizes appropriate for SD content.

The left diagrams of FIG. 6 show a sequence of data storing in the video buffer 13V having a buffer size appropriate for SD video.

In the left diagrams of FIG. 6, a size V_{S} is set as the buffer size appropriate for SD video, and the video buffer 13V having the buffer size V_{S} can store e.g. two pictures (or three pictures) of SD video.

As shown in the left uppermost diagram of FIG. 6, if the n-th SD video #n and the n+1-th SD video #n+1 are stored in the video buffer 13V having the buffer size V_{S}, at the timing of decoding of the n-th SD video #n, which is the earliest data stored in the video buffer 13V, the n-th SD video #n is read out from the video buffer 13V so as to be supplied to the decoder 14 at the subsequent stage.

Furthermore, as shown in the left middle diagram of FIG. 6, the n+2-th SD video #n+2 next to the n+1-th SD video #n+1, which is the latest data stored in the video buffer 13V, is supplied from the demultiplexer 12 at the previous stage to the video buffer 13V and stored therein.

Subsequently, at the timing of decoding of the n+1-th SD video #n+1 as the earliest data stored in the video buffer 13V, the n+1-th SD video #n+1 is read out from the video buffer 13V so as to be supplied to the decoder 14 at the subsequent stage.

Furthermore, as shown in the left lowermost diagram of FIG. 6, the n+3-th SD video #n+3 next to the n+2-th SD video #n+2, which is the latest data stored in the video buffer 13V, is supplied from the demultiplexer 12 at the previous stage to the video buffer 13V and stored therein.

Also from then on, reading/writing of SD video from/to the video buffer 13V is similarly carried out.

The right diagrams of FIG. 6 show a sequence of data storing in the audio buffer 13A having a buffer size appropriate for SD audio associated with SD video.

In the right diagrams of FIG. 6, a size V_{S}′ is set as the buffer size appropriate for SD audio, and the audio buffer 13A having the buffer size V_{S}′ can store SD audio associated with e.g. two pictures (or three pictures) of SD video.

Specifically, the video stored in the video buffer 13V and the audio stored in the audio buffer 13A are video and audio that should be output at substantially the same time (video and audio corresponding to each other). Therefore, when the n-th SD video #n and the n+1-th SD video #n+1 are stored in the video buffer 13V as shown in the left uppermost diagram of FIG. 6, SD audio #n associated with the n-th SD video #n and SD audio #n+1 associated with the n+1-th SD video #n+1 are stored in the audio buffer 13A as shown in the right uppermost diagram of FIG. 6.

If an MPEG stream includes one video stream and a first audio stream and a second audio stream as two kinds of audio streams as shown in FIG. 5 and outputting of e.g. the first audio stream as one of the first and second audio streams is selected, regarding the audio stream, the demultiplexer 12 (FIG. 1) separates the first audio stream from the MPEG stream and supplies the first audio stream to the audio buffer 13A in the memory 13.

Therefore, in the present case, under the definition that SD audio included in the first audio stream is referred to as SD first audio and SD audio included in the second audio stream is referred to as SD second audio, SD first audio #n associated with the n-th SD video #n and SD first audio #n+1 associated with the n+1-th SD video #n+1 are stored in the audio buffer 13A in the memory 13.

Similarly to the video stored in the video buffer 13V, the audio stored in the audio buffer 13A is also read out from the audio buffer 13A at the timing of decoding thereof so as to be supplied to the decoder 14 at the subsequent stage.

Thus, the video and audio are output with the synchronization therebetween (audio visual (AV) synchronization) kept.

As described above, in the audio buffer 13A, the audio corresponding to the video stored in the video buffer 13V is stored. Therefore, at the same timing as (at a timing close to) the timing when the SD video #n is read out from the video buffer 13V and the n+2-th SD video #n+2 is supplied from the demultiplexer 12 at the previous stage to the video buffer 13V and stored therein as described with the left diagrams of FIG. 6, the SD first audio #n associated with the SD video #n is read out from the audio buffer 13A and the SD first audio #n+2 associated with the n+2-th SD video #n+2 is supplied from the demultiplexer 12 at the previous stage to the audio buffer 13A and stored therein.

However, if a user carries out operation to switch the audio output from the SD first audio to the SD second audio at the timing of reading-out of the SD first audio #n from the audio buffer 13A, buffer flush of the audio buffer 13A, i.e., discarding of the SD first audio #n and #n+1 stored in the audio buffer 13A, is carried out (the data stored in the audio buffer 13A is cleared) as shown in the right middle diagram of FIG. 6. Thereafter, the demultiplexer 12 (FIG. 1) changes the audio stream to be separated from the MPEG stream from the first audio stream to the second audio stream, and supplies the second audio stream to the audio buffer 13A in the memory 13.

The supply of the second audio stream separated from the MPEG stream to the audio buffer 13A from the demultiplexer 12 is begun from SD second audio #n+2 subsequent to the SD first audio #n+1, which was the latest data stored in the audio buffer 13A when the buffer flush of the audio buffer 13A was carried out.

Therefore, immediately after the buffer flush of the audio buffer 13A, the SD second audio #n+2 and #n+3 are stored in the audio buffer 13A as shown in the right lowermost diagram of FIG. 6.

Subsequently, the SD second audio #n+2 stored in the audio buffer 13A is read out at the timing offering AV synchronization with the outputting (displaying) of the SD video #n+2, which is stored in the video buffer 13V and associated with the SD second audio #n+2, so that the read-out SD second audio #n+2 is supplied to the decoder 14 at the subsequent stage.

Therefore, if a user carries out operation to switch the audio output from the SD first audio to the SD second audio at the timing of reading-out of the SD first audio #n from the audio buffer 13A, the buffer flush of the audio buffer 13A is carried out although buffer flush of the video buffer 13V is not carried out and hence SD video is continuously output. Thus, in the buffer flush, the SD audio (SD first audio) #n and #n+1 associated with the SD video #n and #n+1 stored in the video buffer 13V are discarded. As a result, a silent state continues during the outputting of the SD video #n and #n+1.

Thereafter, the outputting of the SD audio (SD second audio) is restarted at the timing of outputting of the SD video #n+2 associated with the SD second audio #n+2, which is the earliest data stored in the audio buffer 13A after the buffer flush.

Consequently, when the buffer sizes of the video buffer 13V and the audio buffer 13A are ones appropriate for SD content, a silent time is short, which arises in response to output switching from one of the SD first audio and SD second audio to the other.

On the other hand, when the buffer sizes of the video buffer 13V and the audio buffer 13A are ones appropriate for HD content and thus SD video having a data amount more than necessary can be stored in the video buffer 13V, a long silent time will arise in response to output switching from one of the SD first audio and SD second audio to the other.

Specifically, FIG. 7 shows a sequence of data storing in the video buffer 13V and the audio buffer 13A that have buffer sizes appropriate for HD content.

The left diagrams of FIG. 7 show a sequence of data storing in the video buffer 13V having a buffer size appropriate for HD video.

In the left diagrams of FIG. 7, a size V_{H} is set as the buffer size appropriate for HD video, and the video buffer 13V having the buffer size V_{H} can store e.g. ten pictures (or more pictures) of SD video.

As shown in the left uppermost diagram of FIG. 7, if SD video data from the n-th SD video #n to the n+9-th SD video #n+9 are stored in the video buffer 13V having the buffer size V_{H}, at the timing of decoding of the n-th SD video #n, which is the earliest data stored in the video buffer 13V, the n-th SD video #n is read out from the video buffer 13V so as to be supplied to the decoder 14 at the subsequent stage.

Furthermore, as shown in the left middle diagram of FIG. 7, the n+10-th SD video #n+10 next to the n+9-th SD video #n+9, which is the latest data stored in the video buffer 13V, is supplied from the demultiplexer 12 at the previous stage to the video buffer 13V and stored therein.

Subsequently, at the timing of decoding of the n+1-th SD video #n+1 as the earliest data stored in the video buffer 13V, the n+1-th SD video #n+1 is read out from the video buffer 13V so as to be supplied to the decoder 14 at the subsequent stage.

Furthermore, as shown in the left lowermost diagram of FIG. 7, the n+11-th SD video #n+11 next to the n+10-th SD video #n+10, which is the latest data stored in the video buffer 13V, is supplied from the demultiplexer 12 at the previous stage to the video buffer 13V and stored therein.

Also from then on, reading/writing of SD video from/to the video buffer 13V is similarly carried out.

The right diagrams of FIG. 7 show a sequence of data storing in the audio buffer 13A having a buffer size appropriate for HD audio associated with HD video.

In the right diagrams of FIG. 7, a size V_{H}′ is set as the buffer size appropriate for HD audio, and the audio buffer 13A having the buffer size V_{H}′ can store SD audio associated with ten pictures (or more pictures) of SD video, which correspond to the ten pictures (or more pictures) of SD video that can be stored in the video buffer 13V having the buffer size V_{H} shown in the left diagrams of FIG. 7.

Therefore, when the SD video data from the n-th SD video #n to the n+9-th SD video #n+9 are stored in the video buffer 13V as shown in the left uppermost diagram of FIG. 7, SD audio #n to #n+9 that are associated with the SD video #n to #n+9, respectively, are stored in the audio buffer 13A as shown in the right uppermost diagram of FIG. 7.

If an MPEG stream includes one video stream and a first audio stream and a second audio stream as two kinds of audio streams as shown in FIG. 5 and outputting of e.g. the first audio stream as one of the first and second audio streams is selected, regarding the audio stream, the demultiplexer 12 (FIG. 1) separates the first audio stream from the MPEG stream and supplies the first audio stream to the audio buffer 13A in the memory 13.

Therefore, in the present case, SD first audio #n to #n+9 are stored in the audio buffer 13A in the memory 13.

The SD first audio #n, which is the earliest data stored in the audio buffer 13A, is read out from the audio buffer 13A with the AV synchronization so as to be supplied to the decoder 14 at the subsequent stage. Furthermore, SD first audio #n+10 next to the SD first audio #n+9, which is the latest data stored in the audio buffer 13A, is supplied from the demultiplexer 12 at the previous stage to the audio buffer 13A and stored therein.

Similarly to the above description with FIG. 6, if a user carries out operation to switch the audio output from the SD first audio to the SD second audio at the timing of reading-out of the SD first audio #n from the audio buffer 13A, buffer flush of the audio buffer 13A is carried out, so that the SD first audio #n to #n+9 stored in the audio buffer 13A are discarded as shown in the right middle diagram of FIG. 7. Thereafter, the demultiplexer 12 (FIG. 1) changes the audio stream to be separated from the MPEG stream from the first audio stream to the second audio stream, and supplies the second audio stream to the audio buffer 13A in the memory 13.

As described above with FIG. 6, the supply of the second audio stream separated from the MPEG stream to the audio buffer 13A from the demultiplexer 12 is begun from the SD second audio subsequent to the SD first audio that was the latest data stored in the audio buffer 13A when the buffer flush of the audio buffer 13A was carried out.

Therefore, immediately after the buffer flush of the audio buffer 13A, as shown in the right lowermost diagram of FIG. 7, SD second audio for ten pictures from SD second audio #n+10 subsequent to the SD first audio #n+9, which was the latest data stored in the audio buffer 13A at the timing of the buffer flush, are stored in the audio buffer 13A. That is, the SD second audio #n+10 to #n+19 are stored.

Subsequently, the SD second audio #n+10, which is the earliest data among the SD second audio #n+10 to #n+19 stored in the audio buffer 13A, is read out at the timing offering AV synchronization with the outputting (displaying) of the SD video #n+10, which is stored in the video buffer 13V and associated with the SD second audio #n+10, so that the read-out SD second audio #n+10 is supplied to the decoder 14 at the subsequent stage.

Therefore, if a user carries out operation to switch the audio output from the SD first audio to the SD second audio at the timing of reading-out of the SD first audio #n from the audio buffer 13A, the buffer flush of the audio buffer 13A is carried out although buffer flush of the video buffer 13V is not carried out and hence SD video is continuously output. Thus, in the buffer flush, the SD audio (SD first audio) #n to #n+9 associated with the SD video #n to #n+9 stored in the video buffer 13V are discarded. As a result, a silent state continues during the outputting of the SD video #n to #n+9.

Thereafter, the outputting of the SD audio (SD second audio) is restarted at the timing of the outputting of the SD video #n+10.

Consequently, the silent state continues during the displaying of the SD video #n to #n+9, i.e., for a long time equivalent to the time for ten pictures.

If the buffer size of the video buffer 13V is set to the buffer size V_{H} appropriate for HD video as described above, SD video, whose data amount D_{S} is smaller than that of HD video, having a data amount more than necessary can be stored in the video buffer 13V. Therefore, the buffer flush of the audio buffer 13A often causes a long silent time.

Such a phenomenon possibly occurs also regarding video. Specifically, for example, if an MPEG stream includes a first kind of video stream and a second kind of video stream as video streams and the video output is switched from one of the first and second kinds of video stream to the other in response to user's operation or the like, buffer flush of the video buffer 13V needs to be carried out. The buffer flush of the video buffer 13V often causes the continuation of a blank state in which video is not displayed (or video freezes) for a long time.

For example, if the reading-out of the SD second audio #n+10 to #n+19 stored in the audio buffer 13A after the buffer flush of the audio buffer 13A is immediately started (the outputting of audio is started based on so-called free run) in FIG. 7, the occurrence of a silent time can be prevented. However, in this case, AV synchronization cannot be ensured, i.e., SD video and SD audio associated with the SD video are output with time lag therebetween, which causes a user to feel a sense of discomfort.

As a countermeasure thereagainst, a method would be possible in which the memory 13 is provided with a buffer in which a first audio stream including SD first audio is stored and a buffer in which a second audio stream including SD second audio is stored.

Specifically, FIG. 8 shows another configuration example of the memory 13 of FIG. 1.

In FIG. 8, the same part as that in FIG. 2 is given the same numeral.

The memory 13 of FIG. 8 has the same configuration as that of the memory 13 of FIG. 2, except that two audio buffers 13A₁ and 13A₂ are provided instead of one audio buffer 13A and a switch SW is additively provided.

Referring to FIG. 8, the demultiplexer 12 separates a video stream, a first audio stream, and a second audio stream from an MPEG stream, and supplies the video stream, the first audio stream, and the second audio stream to the video buffer 13V, the audio buffer 13A₁, and the audio buffer 13A₂, respectively.

The first audio stream supplied from the demultiplexer 12 is temporarily stored in the audio buffer 13A₁, followed by being supplied to one of two terminals of the switch SW.

The second audio stream supplied from the demultiplexer 12 is temporarily stored in the audio buffer 13A₂, followed by being supplied to the other of two terminals of the switch SW.

The switch SW selects either one of two terminals in accordance with user's operation or the like to thereby supply the audio stream supplied from either one of the audio buffers 13A₁ and 13A₂ to the audio decoder 14A.

By providing the memory 13 with two audio buffers 13A₁ and 13A₂ and the switch SW as described above, the occurrence of a long silent time like that described with FIG. 7 can be prevented by changing the selection of the switch SW in response to switching of the audio output from one of audio of the first audio stream and audio of the second audio stream to the other.

However, in this case, the cost of the TV is high because two audio buffers 13A₁ and 13A₂ and the switch SW are necessary.

Furthermore, if the case is also taken into consideration in which an MPEG stream includes a first kind of video stream and a second kind of video stream and the video output is switched from one of the first and second kinds of video stream to the other, the video buffer 13V also needs to be replaced by two buffers: a buffer in which the first kind of video stream is stored and a buffer in which the second kind of video stream is stored. This further increases the cost.

In the TV of FIG. 1, as described with FIGS. 6 and 7, if the audio output is switched between the first audio stream and the second audio stream, specifically from the first audio stream to the second audio stream for example, after the buffer flush of the audio buffer 13A, the supply of audio to the audio buffer 13A from the demultiplexer 12 is begun from the SD second audio subsequent to the SD first audio that was the latest data stored in the audio buffer 13A immediately before the buffer flush. This is due to a feature that the MPEG stream supplied to the demultiplexer 12 is a so-called push stream, which is sent by broadcasting such as terrestrial digital broadcasting.

The push stream refers to a stream that is sent from the transmission side irrespective of the state of the reception side. On the other hand, a stream that is sent from the transmission side in response to a request by the reception side or the like is referred to as a pull stream.

If an MPEG stream includes two kinds of audio streams of a first audio stream and a second audio stream but the memory 13 has only one audio buffer 13A as shown in FIG. 2, the demultiplexer 12 needs to separate either one of the first audio stream and the second audio stream from an MPEG stream and supply the separated stream to the audio buffer 13A because only one kind of audio stream can be stored in one audio buffer 13A. Thus, the other audio stream is discarded.

In an MPEG stream, SD first audio and SD second audio corresponding to certain SD video are multiplexed at positions close to each other. Therefore, when SD first audio corresponding to certain SD video is stored in the audio buffer 13A after being separated from an MPEG stream, the SD second audio corresponding to the certain SD video has been already discarded in many cases.

For this reason, in the case of the switching of the audio output from the first audio stream to the second audio stream, after the buffer flush of the audio buffer 13A, the separation from an MPEG stream and the supply to the audio buffer 13A by the demultiplexer 12 is begun from the SD second audio subsequent to the SD first audio that was the latest data stored in the audio buffer 13A immediately before the buffer flush.

On the other hand, if an MPEG stream supplied to the demultiplexer 12 is a pull stream, a method would be possible in which the occurrence of a silent time is prevented by requesting that the SD second audio discarded by the demultiplexer 12 be supplied again.

Specifically, if the MPEG stream supplied to the demultiplexer 12 via the external input 11 (FIG. 1) is one supplied from a reproducing device for reproduction from a disk-shape recording medium, such as a DVD player, the following method would be possible to prevent the occurrence of a silent time. Specifically, the SD second audio discarded by the demultiplexer 12 is recognized based on the number of rotations of the disk-shape recording medium and so on, and a request to read out the recognized SD second audio again is issued to the reproducing device to thereby acquire the SD second audio from the reproducing device again.

However, it is not easy to separately develop hardware and software for executing processing of recognizing the SD second audio discarded by the demultiplexer 12 and requesting the reproducing device to read out the recognized SD second audio again to thereby acquire the SD second audio from the reproducing device.

Furthermore, if an MPEG stream recorded in a disk-shape recording medium is stored in a file like e.g. a moving picture captured by a digital camera, it is difficult to acquire the SD second audio discarded by the demultiplexer 12 from the reproducing device again unless the position of the SD second audio in the file is known.

There is a need for the present invention to allow reduction in the cost of a device (prevention of increase in the cost of a device).

According to one embodiment of the present invention, there is provided a data processing device that processes a bit stream including at least first data and second data, or a program for causing a computer to function as the data processing device. The data processing device includes a buffer size setting unit configured to set, of a first buffer size of a first buffer and a second buffer size of a second buffer, the first buffer size based on information included in the bit stream. The first buffer temporarily stores the first data and supplies the first data to a first decoder. The second buffer temporarily stores the second data and supplies the second data to a second decoder. The data processing device further includes a buffer controller configured to control the buffer size of the first buffer to the first buffer size.

According to one embodiment of the present invention, there is provided a data processing method for processing a bit stream including at least first data and second data. The method includes the step of setting, of a first buffer size of a first buffer and a second buffer size of a second buffer, the first buffer size based on information included in the bit stream. The first buffer temporarily stores the first data and supplies the first data to a first decoder. The second buffer temporarily stores the second data and supplies the second data to a second decoder. The method further includes the step of controlling the buffer size of the first buffer to the first buffer size.

In the above-described embodiments, of the first buffer size of the first buffer that temporarily stores the first data and supplies the first data to the first decoder and the second buffer size of the second buffer that temporarily stores the second data and supplies the second data to the second decoder, the first buffer size is set based on information included in the bit stream. Furthermore, the buffer size of the first buffer is controlled to the first buffer size.

The program can be provided through transmission via a transmission medium or recording in a recording medium.

The data processing device may be an independent device, or alternatively may be an internal block serving as an independent device.

The embodiments of the present invention allow reduction in the cost of the device.

### BRIEF DESCRIPTION OF THE DRAWINGS

FIG. 1 is a block diagram showing the configuration of one example of a related-art TV;

FIG. 2 is a block diagram showing a configuration example of a memory and a decoder;

FIG. 3 is a block diagram showing a configuration example of a TV provided with a block for processing SD content and a block for processing HD content;

FIGS. 4A and 4B are diagrams for explaining the buffer sizes of a video buffer necessary for SD content and HD content, respectively;

FIG. 5 is a diagram showing an example of an MPEG stream;

FIG. 6 is a diagram showing a sequence of data storing in the video buffer and an audio buffer that have buffer sizes appropriate for SD content;

FIG. 7 is a diagram showing a sequence of data storing in the video buffer and the audio buffer that have buffer sizes appropriate for HD content;

FIG. 8 is a block diagram showing another configuration example of the memory;

FIG. 9 is a block diagram showing a configuration example of a TV according to one embodiment of the present invention;

FIG. 10 is a block diagram showing a configuration example of a memory, a decoder, and a controller;

FIG. 11 is a flowchart for explaining buffer control processing;

FIG. 12 is a diagram for explaining control of the buffer sizes of a video buffer and an audio buffer;

FIG. 13 is a diagram showing a sequence of data storing in the video buffer and the audio buffer;

FIG. 14 is a diagram showing a sequence of data storing in the video buffer and the audio buffer;

FIG. 15 is a diagram for explaining the substantial change of the buffer size of the video buffer through control of the overflow threshold;

FIG. 16 is a diagram showing a sequence of data storing in the video buffer when an overflow threshold is changed from a large value to a small value; and

FIGS. 17A and 17B are diagrams showing a configuration example of the video buffer formed of a ring buffer.

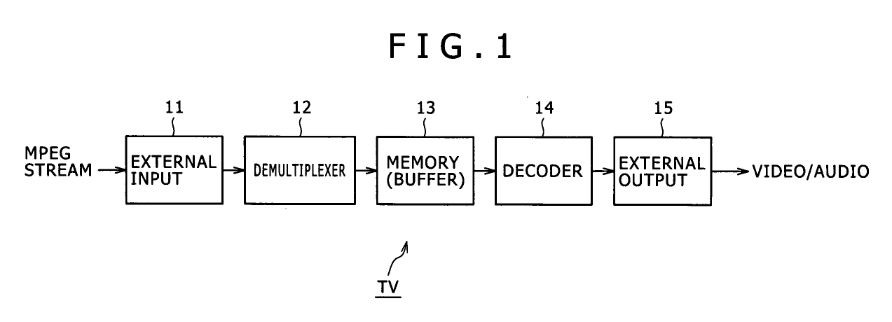

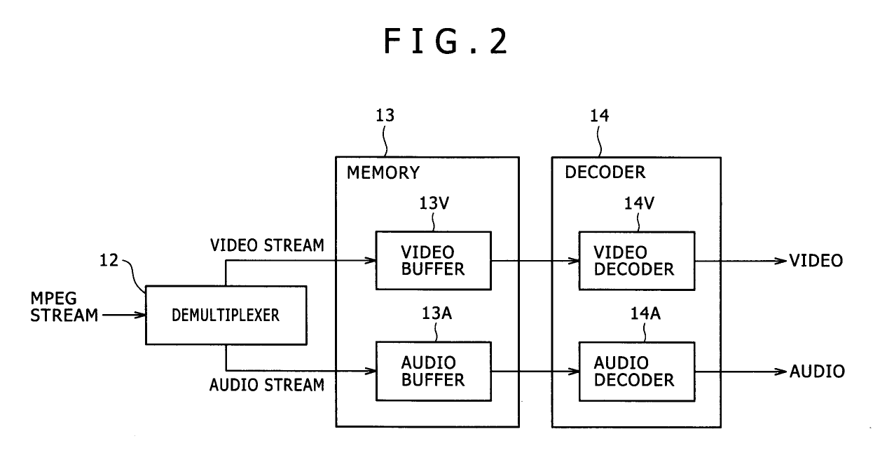

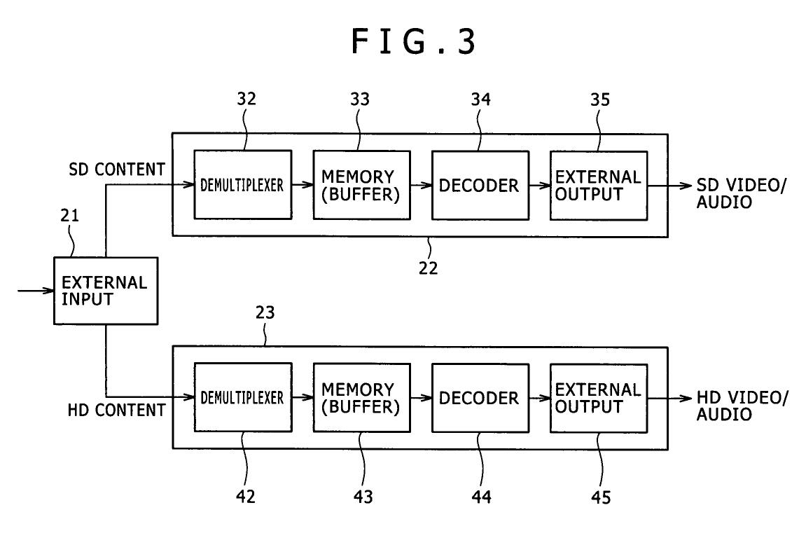

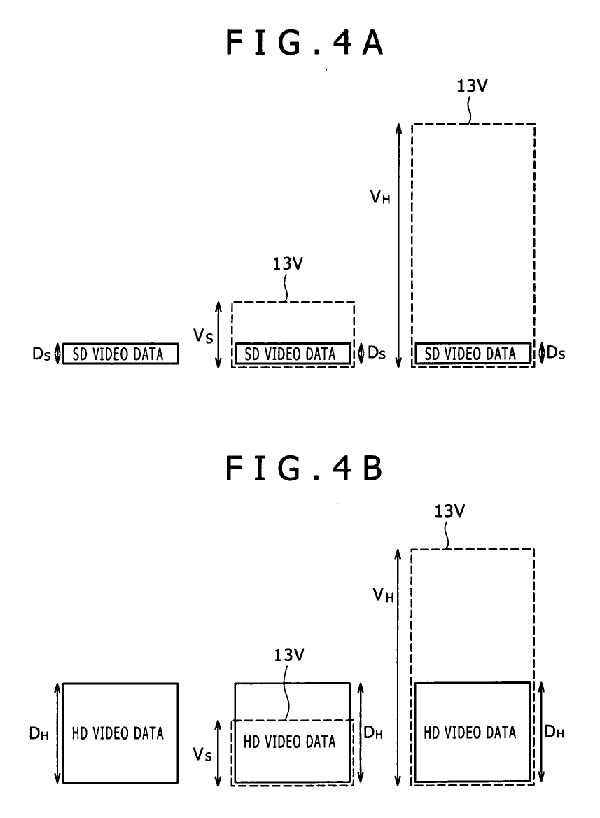

### DETAILED DESCRIPTION OF THE PREFERRED EMBODIMENT

An embodiment of the present invention will be described below, and the description of exemplification of the correspondence relationship between constituent features of the present invention and the embodiment described in the specification or drawings is as follows. This description is made to confirm the fact that the embodiment supporting the present invention is described in the specification or drawings. Therefore, even if there is an embodiment that is not described in the following description as an embodiment corresponding to constituent features of the present invention although being described in the specification or drawings, this does not mean that the embodiment does not correspond to the constituent features. On the other hand, even if an embodiment is described in the following description as an embodiment corresponding to constituent features, this does not mean that the embodiment does not correspond to constituent features other than the constituent features.

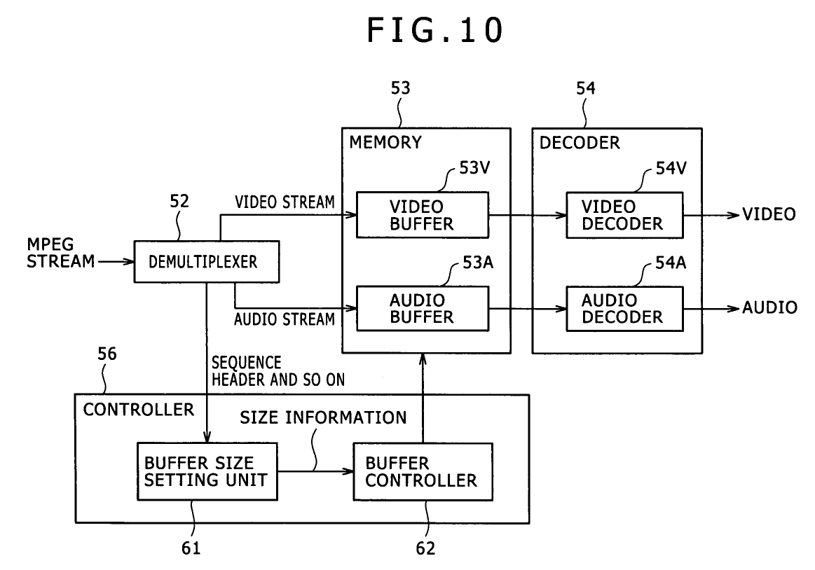

A data processing device or a program according to one embodiment of the present invention is a data processing device that processes a bit stream including at least first data and second data or a program for causing a computer to function as the data processing device. The data processing device includes buffer size setting means (e.g., a buffer size setting unit 61 of FIG. 10) configured to set, of a first buffer size of a first buffer (e.g., a video buffer 53V of FIG. 10) that temporarily stores the first data (e.g., a video stream as a stream of video data) and supplies the first data to a first decoder (e.g., a video decoder 54V of FIG. 10) and a second buffer size of a second buffer (e.g., an audio buffer 53A of FIG. 10) that temporarily stores the second data (e.g., an audio stream as a stream of audio data) and supplies the second data to a second decoder (e.g., an audio decoder 54A of FIG. 10), the first buffer size based on information included in the bit stream (e.g., a sequence header included in an MPEG stream), and buffer controlling means (e.g., a buffer controller 62 of FIG. 10) configured to control the buffer size of the first buffer to the first buffer size.

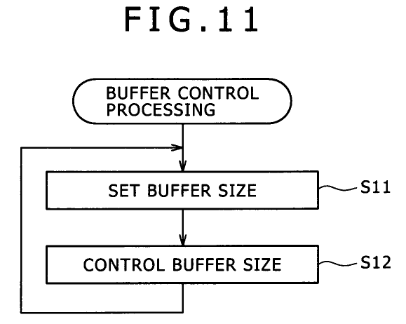

A data processing method according to one embodiment of the present invention is a data processing method for processing a bit stream including at least first data and second data. The method includes the steps of setting (e.g., in a step S11 of FIG. 11), of a first buffer size of a first buffer (e.g., the video buffer 53V of FIG. 10) that temporarily stores the first data (e.g., a video stream as a stream of video data) and supplies the first data to a first decoder (e.g., the video decoder 54V of FIG. 10) and a second buffer size of a second buffer (e.g., the audio buffer 53A of FIG. 10) that temporarily stores the second data (e.g., an audio stream as a stream of audio data) and supplies the second data to a second decoder (e.g., the audio decoder 54A of FIG. 10), the first buffer size based on information included in the bit stream (e.g., a sequence header included in an MPEG stream), and controlling (e.g., in a step S12 of FIG. 11) the buffer size of the first buffer to the first buffer size.

An embodiment of the present invention will be described below with reference to the accompanying drawings.

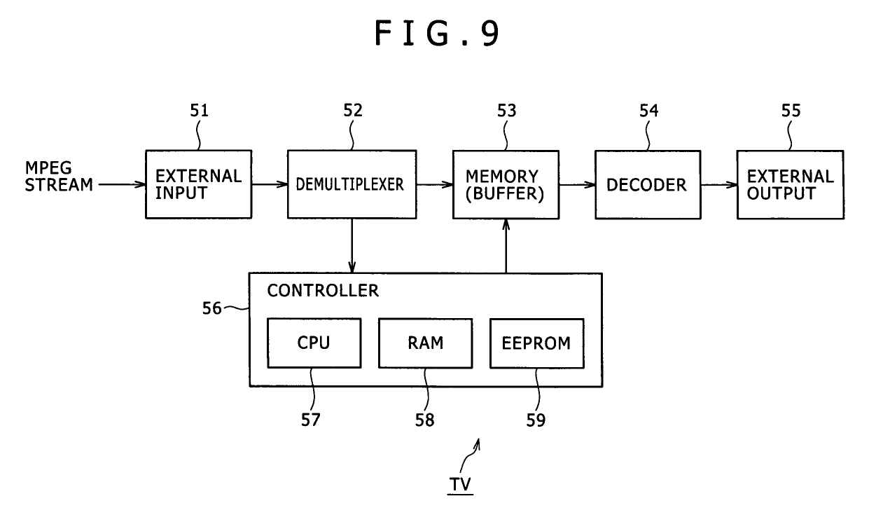

FIG. 9 is a block diagram showing a configuration example of a TV according to one embodiment of the present invention.

The outline of the TV of FIG. 9 will be described below.

The TV includes an external input 51 that captures video/audio content via the USB (Universal Serial Bus), Ethernet (registered trademark), and so forth, a demultiplexer 52 that sorts these multiplexed data into various kinds of data such as audio data and video data, a memory 53 that holds various kinds of data, and a decoder 54 that processes (decodes) the data in the memory 53.

Because of the appearance of various high-function recording devices and recording media, it is expected that a wide variety of content will be captured through the external input 51. Due to enhancement in functions of a central processing unit (CPU) and so on, there are many kinds of chips including the demultiplexer 52 and the decoder 54 that can treat various kinds of formats.

On the other hand, as for the memory 53, it is desired that the memory use amount be decreased by making ingenuity such as sharing as much as possible.

In reproduction of video/audio content in the TV, profile information, video size information, VBV buffer information, and bit rate information are acquired from sequence header information captured by a video ES buffer (video buffer 53V of FIG. 10 to be described later) in the memory 53, and the ES buffer size (the buffer size of the video buffer 53V of FIG. 10 to be described later) is changed based on the acquired information.

In the TV, after the matching of the video size information with the profile information is confirmed, these two kinds of information are used as major determination values, so that the maximum total VBV buffer amount defined by the profile in which the obtained video size is encompassed is used as the ES buffer size. As for content whose profile information and video size information do not match each other and content having no profile regulation, such as content of the MPEG1 format, the TV gives the priority to the video size information and thus sets the information as the profile-defining maximum VBV value. The TV carries out detailed setting through Verify and fine adjustment based on the VBV buffer information and the bit rate information. The TV takes into consideration the possibility that the VBV buffer information and the bit rate information include incorrect value and greatly-abnormal value, and the TV gives a range to the buffer size change and does not use a value outside the range.

The TV dynamically changes the ES buffer every time a sequence header is captured, and thereby can minimize the information amount discarded at the time of buffer flush even for content including mixture of HD and SD. This can reduce silent time and blank time (freeze time) and allows re-reproduction with AV synchronization, which can decrease a sense of discomfort of a user. Furthermore, this system makes it possible to treat a push stream such as a broadcasting stream and a pull stream like the above-described one in the same memory area, which leads to cost reduction.

Although originally it is ideal to determine the buffer size based on the VBV buffer information, the determination based on only this information is impractical because there is also a great deal of content in which information on this part is incorrect. Originally the VBV buffer information is a value based on the assumption that the decoder operates under an ideal condition and will not define a system for realizing a practical decoder. Therefore, if a value smaller than the necessary amount is written as the VBV buffer information, there is a risk of the failure of the buffer. Also as for the bit rate information, the maximum bit rate in the specification is written in many cases. Therefore, if the buffer size is determined mainly based on this information, the possibility that only the same advantage as that obtained when the ES buffer size is not dynamically changed can be obtained is high. Consequently, in the TV, the VBV buffer information and the bit rate information are not used as information for final determination but used for Verify and fine adjustment of determination information. This allows the TV to be compatible with a great number of format files that are available practically.

Details of the TV of FIG. 9 will be described below.

Referring to FIG. 9, the TV includes the external input 51, the demultiplexer 52, the memory 53, the decoder 54, an external output 55, and a controller 56.

The external input 51 is any of e.g. the following components: a tuner that receives a terrestrial digital broadcast or another broadcast and outputs an MPEG stream; a communication interface that receives and outputs an MPEG stream by carrying out communication compliant with the standard of the USB, LAN (local area network), or IEEE (Institute of Electrical and Electronics Engineers) 1394 with external apparatus (not shown); and a drive that reads out an MPEG stream from a memory card such as Memory Stick (registered trademark) or another recording medium and outputs the read-out MPEG stream. The MPEG stream output from the external input 51 is supplied to the demultiplexer 52.

The demultiplexer 52 separates e.g. a video stream as an ES of video data and an audio stream as an ES of audio data from the MPEG stream from the external input 51, and supplies these streams to the memory 53.

Furthermore, the demultiplexer 52 separates from the MPEG stream from the external input 51 a sequence header and other various headers (information thereon) as information relating to the video data and audio data included in the MPEG stream, and supplies these headers to the controller 56.

The video and audio streams from the demultiplexer 52 are temporarily stored (buffered) in the memory 53, followed by being supplied to the decoder 54 therefrom.

Specifically, in order to adjust the data amounts of the video and audio streams that are to be supplied to the decoder 54 at the subsequent stage, the memory 53 temporarily stores the video and audio streams supplied from the demultiplexer 52, and then supplies these streams to the decoder 54.

The decoder 54 decodes the video stream from the memory 53 by e.g. a system compliant with the MPEG standard, and supplies the resulting baseband video data to the external output 55. Furthermore, the decoder 54 decodes the audio stream from the memory 53, and supplies the resulting baseband audio data to the external output 55.

The external output 55 supplies the video data from the decoder 54 to a display (not shown) such as a liquid crystal display (LCD) or an organic electroluminescence (EL) display, so that the corresponding picture is displayed thereon. In addition, the external output 55 supplies the audio data from the decoder 54 to a speaker (not shown), so that the corresponding audio (sound) is output therefrom.

The controller 56 includes a CPU 57, a random access memory (RAM) 58, and an electrically erasable programmable read only memory (EEPROM) 59, and controls the memory 53 based on the information from the demultiplexer 52.

Specifically, the CPU 57 executes a program stored in the EEPROM 59 to thereby execute buffer control processing and so forth for the control of the memory 53.

The RAM 58 temporarily stores data and so on necessary for the operation of the CPU 57.

The EEPROM 59 stores a program to be executed by the CPU 57 and so forth.

The program to be executed by the CPU 57 may be stored in the EEPROM 59 in advance. Alternatively, it is also possible to record the program in a removable recording medium, such as a flexible disc, compact disc read only memory (CD-ROM), magneto optical (MO) disc, DVD, magnetic disc, or semiconductor memory, and install the program in the EEPROM 59 in the TV from the removable recording medium.

More alternatively, it is also possible to transmit the program to the TV via a wireless transmission medium such as a digital broadcast or via a wired transmission medium such as the Internet, and install the thus transmitted program in the EEPROM 59 in the TV.

This scheme for installing a program in the EEPROM 59 by using a removable recording medium or a transmission medium can be used also for the version upgrade of a program stored in the EEPROM 59.

FIG. 10 is a block diagram showing a configuration example of the memory 53, the decoder 54, and the controller 56 of FIG. 9.

The memory 53 includes one video buffer 53V and one audio buffer 53A.

To the video buffer 53V, a video stream from the demultiplexer 52 is supplied. The video stream from the demultiplexer 52 is temporarily stored in the video buffer 53V, followed by being supplied to the decoder 54. The video buffer 53V is equivalent to a VBV buffer.

To the audio buffer 53A, an audio stream from the demultiplexer 52 is supplied. The audio stream from the demultiplexer 52 is temporarily stored in the audio buffer 53A, followed by being supplied to the decoder 54.

The decoder 54 includes a video decoder 54V and an audio decoder 54A.

To the video decoder 54V, the video stream from the video buffer 53V is supplied. The video decoder 54V decodes the video stream from the video buffer 53V, and outputs the resulting video data.

To the audio decoder 54A, the audio stream from the audio buffer 53A is supplied. The audio decoder 54A decodes the audio stream from the audio buffer 53A, and outputs the resulting audio data.

The controller 56 includes a buffer size setting unit 61 and a buffer controller 62. In the controller 56, the CPU 57 of FIG. 9 functions as the buffer size setting unit 61 and the buffer controller 62 by executing a program stored in the EEPROM 59.

Headers such as a sequence header are supplied from the demultiplexer 52 to the buffer size setting unit 61. The buffer size setting unit 61 sets the buffer size of the video buffer 53V and the buffer size of the audio buffer 53A based on the headers from the demultiplexer 52 and so on, and supplies size information indicating these buffer sizes to the buffer controller 62.

The buffer controller 62 controls the buffer size of the video buffer 53V to the buffer size indicated by the size information from the buffer size setting unit 61 and controls the buffer size of the audio buffer 53A to the buffer size indicated by the size information from the buffer size setting unit 61.

The buffer control processing executed by the controller 56 of FIG. 10 will be described below with reference to the flowchart of FIG. 11.

Upon receiving headers such as a sequence header from the demultiplexer 52, in a step S11, the buffer size setting unit 61 in the controller 56 sets the buffer sizes of the video buffer 53V and the audio buffer 53A based on the headers and so on, and supplies size information indicating the respective buffer sizes to the buffer controller 62, so that the processing sequence proceeds to a step S12.

Specifically, the buffer size setting unit 61 obtains a buffer size appropriate for temporal storing of a video stream from the demultiplexer 52 in the video buffer 53V based on e.g. information on the profile, video size, VBV buffer size, bit rate, and so on included in the sequence header among the headers from the demultiplexer 52. In addition, the buffer size setting unit 61 obtains a buffer size appropriate for temporal storing of an audio stream from the demultiplexer 52 in the audio buffer 53A based on information on the codec. Subsequently, the buffer size setting unit 61 supplies the size information indicating the respective buffer sizes to the buffer controller 62.

In the step S12, the buffer controller 62 controls the buffer sizes of the video buffer 53V and the audio buffer 53A to the buffer sizes indicated by the size information from the buffer size setting unit 61.

Specifically, in accordance with the size information from the buffer size setting unit 61, the buffer controller 62 controls the buffer size of the video buffer 53V to a buffer size appropriate for temporal storing of a video stream from the demultiplexer 52 and controls the buffer size of the audio buffer 53A to a buffer size appropriate for temporal storing of an audio stream from the demultiplexer 52.

Subsequently, for example, the controller 56 waits until the next sequence header is supplied from the demultiplexer 52 to the buffer size setting unit 61 and the processing sequence returns to the step S11 from the step S12. From then on, the same processing is repeated.

As described above, due to the controller 56, the buffer size of the video buffer 53V is controlled to a buffer size appropriate for storing of a video stream from the demultiplexer 52, and the buffer size of the audio buffer 53A is controlled to a buffer size appropriate for storing of an audio stream from the demultiplexer 52.

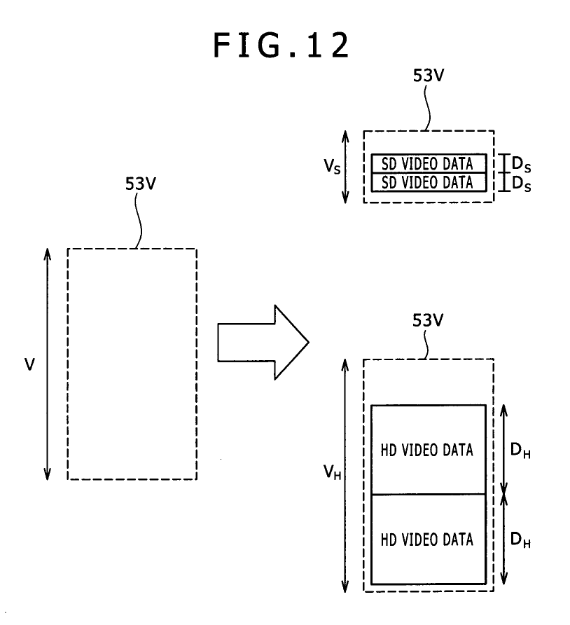

Next, with reference to FIG. 12, the control of the buffer sizes of the video buffer 53V and the audio buffer 53A by the controller 56 will be described below.

The left diagram of FIG. 12 shows the video buffer 53V whose buffer size is controlled to the maximum buffer size V.

The maximum buffer size V of the video buffer 53V is e.g. a size that allows storing of a necessary and sufficient data amount of video data having the largest data amount (highest data rate) among video data to be treated by the TV. For example, the maximum buffer size V is equal to the storage capacity of the memory as hardware of the video buffer 53V.

The right diagrams of FIG. 12 show the video buffer 53V controlled to have a buffer size appropriate for storing of a video stream from the demultiplexer 52.

The present example is based on the assumption that the kinds of video streams to be supplied from the demultiplexer 52 to the video buffer 53V include a video stream of SD content and a video stream of HD content, and one picture of SD video has a data amount D_{S} and one picture of HD video has a data amount D_{H} larger than the data amount D_{S}.

When the video stream to be supplied from the demultiplexer 52 to the video buffer 53V is a video stream of SD content, the controller 56 controls the buffer size of the video buffer 53V to a buffer size V_{S} that allows storing of a necessary and sufficient data amount of SD video. In the example of FIG. 12, the buffer size V_{S} allows storing of e.g. about two pictures of SD video.

When the video stream to be supplied from the demultiplexer 52 to the video buffer 53V is a video stream of HD content, the controller 56 controls the buffer size of the video buffer 53V to a buffer size V_{H} that allows storing of a necessary and sufficient data amount of HD video. In the example of FIG. 12, the buffer size V_{H} is larger than the buffer size V_{S} and allows storing of e.g. about two pictures of HD video.

Similarly to the buffer size of the video buffer 53V, the buffer size of the audio buffer 53A is also controlled by the controller 56 to a buffer size appropriate for temporal storing of an audio stream supplied from the demultiplexer 52 in the audio buffer 53A.

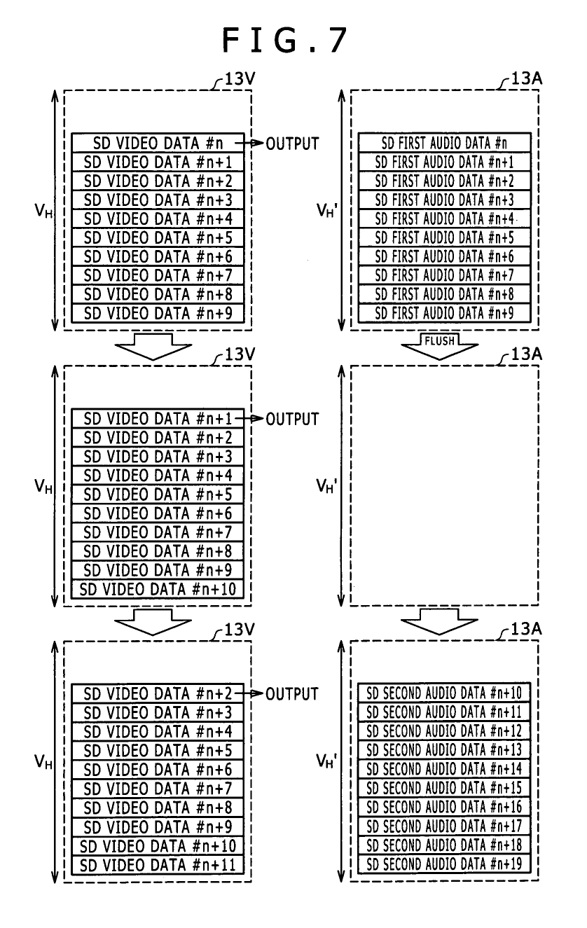

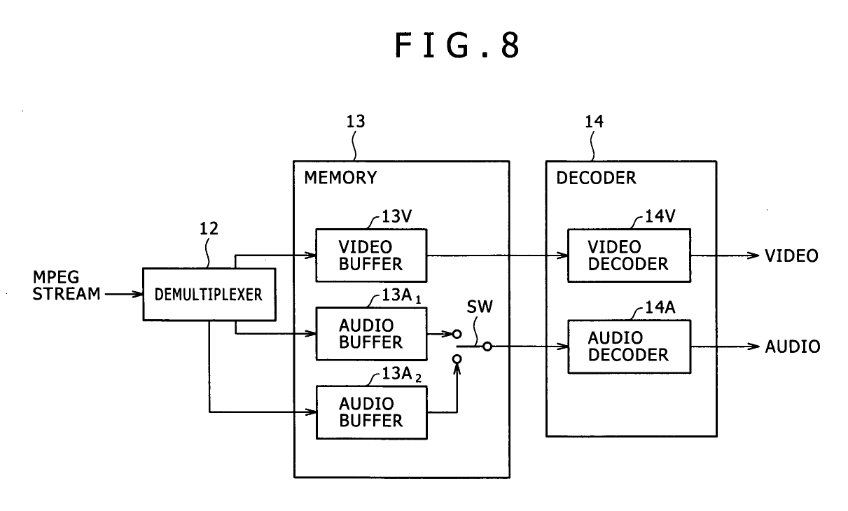

Due to the above-described feature that the controller 56 dynamically controls each of the buffer sizes of the video buffer 53V and the audio buffer 53A to a buffer size appropriate for temporal storing of an ES supplied from the demultiplexer 52, the continuation of a silent or blank state for a long time at the time of buffer flush, described above with FIG. 7, can be prevented without providing groups of plural buffers equivalent to the video buffer 53V and the audio buffer 53A, respectively, i.e., without increase in the cost of the TV.

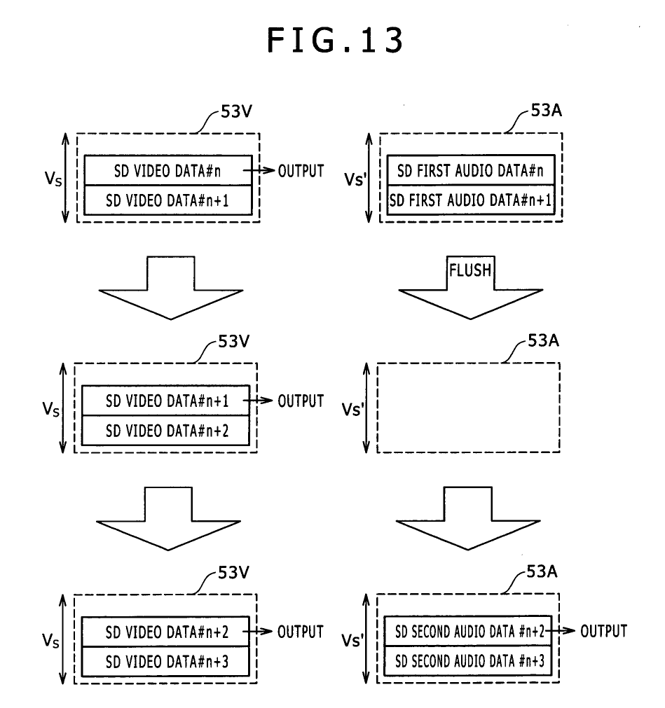

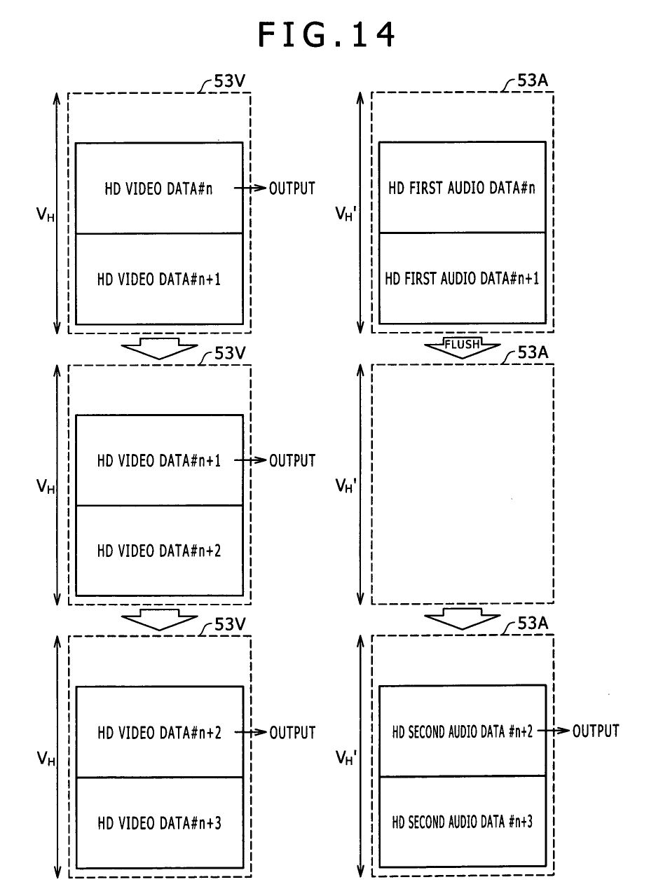

Next, with reference to FIGS. 13 and 14, the operation of the video buffer 53V and the audio buffer 53A controlled to each have an appropriate buffer size by the controller 56 will be described below.

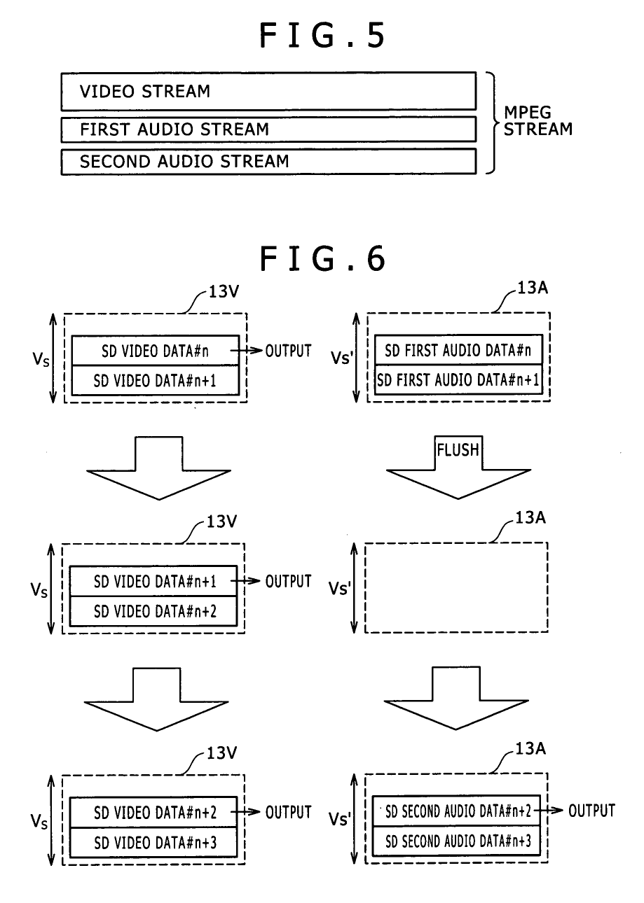

The examples of FIGS. 13 and 14 are based on the following assumption. Specifically, the MPEG stream shown in FIG. 5, which includes one video stream and a first audio stream and a second audio stream as two kinds of audio streams, is supplied from the external input 51 to the demultiplexer 52. Furthermore, the demultiplexer 52 separates the video stream from the MPEG stream and supplies it to the video buffer 53V, and separates the first audio stream or the second audio stream from the MPEG stream and supplies it to the audio buffer 53A.

FIG. 13 shows a sequence of data storing in the video buffer 53V and the audio buffer 53A when the video stream and audio stream supplied from the demultiplexer 52 to the memory 53 are video stream and audio stream of SD content.

Specifically, the left diagrams of FIG. 13 show a sequence of storing of SD video data in the video buffer 53V controlled to have a buffer size appropriate for SD video.

In the left diagrams of FIG. 13, a size V_{S} is set as the buffer size appropriate for SD video, and the video buffer 53V having the buffer size V_{S} can store e.g. two pictures (or three pictures) of SD video.

As shown in the left uppermost diagram of FIG. 13, if the n-th SD video #n and the n+1-th SD video #n+1 are stored in the video buffer 53V having the buffer size V_{S}, at the timing of decoding of the n-th SD video #n, which is the earliest data stored in the video buffer 13V, the n-th SD video #n is read out from the video buffer 53V so as to be supplied to the decoder 54 at the subsequent stage.

Furthermore, as shown in the left middle diagram of FIG. 13, the n+2-th SD video #n+2 next to the n+1-th SD video #n+1, which is the latest data stored in the video buffer 53V, is supplied from the demultiplexer 52 at the previous stage to the video buffer 53V and stored therein.

Subsequently, in the left middle diagram of FIG. 13, at the timing of decoding of the n+1-th SD video #n+1 as the earliest data stored in the video buffer 53V, the n+1-th SD video #n+1 is read out from the video buffer 53V so as to be supplied to the decoder 54 at the subsequent stage.

Furthermore, as shown in the left lowermost diagram of FIG. 13, the n+3-th SD video #n+3 next to the n+2-th SD video #n+2, which is the latest data stored in the video buffer 53V, is supplied from the demultiplexer 52 at the previous stage to the video buffer 53V and stored therein.

Also from then on, reading/writing of SD video from/to the video buffer 53V is similarly carried out.

The right diagrams of FIG. 13 show a sequence of storing of SD audio data in the audio buffer 53A controlled to have a buffer size appropriate for SD audio associated with SD video.

In the right diagrams of FIG. 13, a size V_{S}′ is set as the buffer size appropriate for SD audio, and the audio buffer 53A having the buffer size V_{S}′ can store SD audio associated with e.g. two pictures (or three pictures) of SD video.

Specifically, similarly to the above description with FIG. 6, video and audio corresponding to each other are stored in the video buffer 53V and the audio buffer 53A, respectively. Therefore, when the n-th SD video #n and the n+1-th SD video #n+1 are stored in the video buffer 53V as shown in the left uppermost diagram of FIG. 13, SD audio #n associated with the n-th SD video #n and SD audio #n+1 associated with the n+1-th SD video #n+1 are stored in the audio buffer 53A as shown in the right uppermost diagram of FIG. 13.

If the MPEG stream supplied from the external input 51 to the demultiplexer 52 is an MPEG stream that includes one video stream and a first audio stream and a second audio stream as two kinds of audio streams as shown in FIG. 5 and outputting of e.g. the first audio stream as one of the first and second audio streams is selected, regarding the audio stream, the demultiplexer 52 (FIG. 9) separates the first audio stream from the MPEG stream and supplies the first audio stream to the audio buffer 53A in the memory 53.

Therefore, in the present case, under the definition that SD audio included in the first audio stream is referred to as SD first audio and SD audio included in the second audio stream is referred to as SD second audio, SD first audio #n associated with the n-th SD video #n and SD first audio #n+1 associated with the n+1-th SD video #n+1 are stored in the audio buffer 53A in the memory 53.

The SD audio stored in the audio buffer 53A is read out from the audio buffer 53A so as to be supplied to the decoder 54 at the subsequent stage, at the timing that allows AV synchronization with the SD video that is stored in the video buffer 53V and associated with this SD audio.

As described above, in the audio buffer 53A, the audio corresponding to the video stored in the video buffer 53V is stored. Therefore, at the same timing as (at a timing close to) the timing when the SD video #n is read out from the video buffer 53V and the n+2-th SD video #n+2 is supplied from the demultiplexer 52 at the previous stage to the video buffer 53V and stored therein as described with the left diagrams of FIG. 13, the SD first audio #n associated with the SD video #n is read out from the audio buffer 53A and the SD first audio #n+2 associated with the n+2-th SD video #n+2 is supplied from the demultiplexer 52 at the previous stage to the audio buffer 53A and stored therein.

However, if a user carries out operation to switch the audio output from the SD first audio to the SD second audio at the timing of reading-out of the SD first audio #n from the audio buffer 53A, buffer flush of the audio buffer 53A is carried out, so that the SD first audio #n and #n+1 stored in the audio buffer 53A are discarded as shown in the right middle diagram of FIG. 13.

Thereafter, the demultiplexer 52 (FIG. 9) changes the audio stream to be separated from the MPEG stream from the first audio stream to the second audio stream, and supplies the second audio stream to the audio buffer 53A in the memory 53.

Specifically, the supply of the second audio stream separated from the MPEG stream to the audio buffer 53A from the demultiplexer 52 is begun from SD second audio #n+2 subsequent to the SD first audio #n+1, which was the latest data stored in the audio buffer 53A when the buffer flush of the audio buffer 53A was carried out.

Therefore, immediately after the buffer flush of the audio buffer 53A, the SD second audio #n+2 and #n+3 are stored in the audio buffer 53A as shown in the right lowermost diagram of FIG. 13.

Subsequently, the SD second audio #n+2 stored in the audio buffer 53A is read out at the timing offering AV synchronization with the outputting (displaying) of the SD video #n+2, which is stored in the video buffer 53V and associated with the SD second audio #n+2, so that the read-out SD second audio #n+2 is supplied to the decoder 54 at the subsequent stage.

Therefore, if a user carries out operation to switch the audio output from the SD first audio to the SD second audio at the timing of reading-out of the SD first audio #n from the audio buffer 53A, the buffer flush of the audio buffer 53A is carried out although buffer flush of the video buffer 53V is not carried out and hence SD video is continuously output. Thus, in the buffer flush, the SD audio (SD first audio) #n and #n+1 associated with the SD video #n and #n+1 stored in the video buffer 53V are discarded. As a result, a silent state continues during the outputting of the SD video #n and #n+1. That is, the silent state arises only for a short time.

Thereafter, the outputting of the SD audio (SD second audio #n+2) is restarted at the timing of outputting of the SD video #n+2 associated with the SD second audio #n+2, which is the earliest data stored in the audio buffer 53A after the buffer flush.

FIG. 14 shows a sequence of data storing in the video buffer 53V and the audio buffer 53A when the video stream and audio stream supplied from the demultiplexer 52 to the memory 53 are video stream and audio stream of HD content.

Specifically, the left diagrams of FIG. 14 show a sequence of storing of HD video data in the video buffer 53V controlled to have a buffer size appropriate for HD video.

In the left diagrams of FIG. 14, a size V_{H} is set as the buffer size appropriate for HD video, and the video buffer 53V having the buffer size V_{H} can store e.g. two pictures (or three pictures) of HD video.

As shown in the left uppermost diagram of FIG. 14, if the n-th HD video #n and the n+1-th HD video #n+1 are stored in the video buffer 53V having the buffer size V_{H}, at the timing of decoding of the n-th HD video #n, which is the earliest data stored in the video buffer 53V, the n-th HD video #n is read out from the video buffer 53V so as to be supplied to the decoder 54 at the subsequent stage.

Furthermore, as shown in the left middle diagram of FIG. 14, the n+2-th HD video #n+2 next to the n+1-th HD video #n+1, which is the latest data stored in the video buffer 53V, is supplied from the demultiplexer 52 at the previous stage to the video buffer 53V and stored therein.

Subsequently, at the timing of decoding of the n+1-th HD video #n+1 as the earliest data stored in the video buffer 53V, the n+1-th HD video #n+1 is read out from the video buffer 53V so as to be supplied to the decoder 54 at the subsequent stage.

Furthermore, as shown in the left lowermost diagram of FIG. 14, the n+3-th HD video #n+3 next to the n+2-th HD video #n+2, which is the latest data stored in the video buffer 53V, is supplied from the demultiplexer 52 at the previous stage to the video buffer 53V and stored therein.

Also from then on, reading/writing of HD video from/to the video buffer 53V is similarly carried out.

The right diagrams of FIG. 14 show a sequence of storing of HD audio data in the audio buffer 53A controlled to have a buffer size appropriate for HD audio associated with HD video.

In the right diagrams of FIG. 14, a size V_{H}′ is set as the buffer size appropriate for HD audio, and the audio buffer 53A having the buffer size V_{H}′ can store HD audio associated with e.g. two pictures (or three pictures) of HD video.

Specifically, video and audio corresponding to each other are stored in the video buffer 53V and the audio buffer 53A, respectively. Therefore, when the n-th HD video #n and the n+1-th HD video #n+1 are stored in the video buffer 53V as shown in the left uppermost diagram of FIG. 14, HD audio #n associated with the n-th HD video #n and HD audio #n+1 associated with the n+1-th HD video #n+1 are stored in the audio buffer 53A as shown in the right uppermost diagram of FIG. 14.

If the MPEG stream supplied from the external input 51 to the demultiplexer 52 is an MPEG stream that includes one video stream and a first audio stream and a second audio stream as two kinds of audio streams as shown in FIG. 5 and outputting of e.g. the first audio stream as one of the first and second audio streams is selected, regarding the audio stream, the demultiplexer 52 (FIG. 9) separates the first audio stream from the MPEG stream and supplies the first audio stream to the audio buffer 53A in the memory 53.

Therefore, in the present case, under the definition that HD audio included in the first audio stream is referred to as HD first audio and HD audio included in the second audio stream is referred to as HD second audio, HD first audio #n associated with the n-th HD video #n and HD first audio #n+1 associated with the n+1-th HD video #n+1 are stored in the audio buffer 53A in the memory 53.

The HD audio stored in the audio buffer 53A is read out from the audio buffer 53A so as to be supplied to the decoder 54 at the subsequent stage, at the timing that allows AV synchronization with the HD video that is stored in the video buffer 53V and associated with this HD audio.

As described above, in the audio buffer 53A, the audio corresponding to the video stored in the video buffer 53V is stored. Therefore, at the same timing as (at a timing close to) the timing when the HD video #n is read out from the video buffer 53V and the n+2-th HD video #n+2 is supplied from the demultiplexer 52 at the previous stage to the video buffer 53V and stored therein as described with the left diagrams of FIG. 14, the HD first audio #n associated with the HD video #n is read out from the audio buffer 53A and the HD first audio #n+2 associated with the n+2-th HD video #n+2 is supplied from the demultiplexer 52 at the previous stage to the audio buffer 53A and stored therein.

However, if a user carries out operation to switch the audio output from the HD first audio to the HD second audio at the timing of reading-out of the HD first audio #n from the audio buffer 53A, buffer flush of the audio buffer 53A is carried out, so that the HD first audio #n and #n+1 stored in the audio buffer 53A are discarded as shown in the right middle diagram of FIG. 14.

Thereafter, the demultiplexer 52 (FIG. 9) changes the audio stream to be separated from the MPEG stream from the first audio stream to the second audio stream, and supplies the second audio stream to the audio buffer 53A in the memory 53.

Specifically, the supply of the second audio stream separated from the MPEG stream to the audio buffer 53A from the demultiplexer 52 is begun from HD second audio #n+2 subsequent to the HD first audio #n+1, which was the latest data stored in the audio buffer 53A when the buffer flush of the audio buffer 53A was carried out.

Therefore, immediately after the buffer flush of the audio buffer 53A, the HD second audio #n+2 and #n+3 are stored in the audio buffer 53A as shown in the right lowermost diagram of FIG. 14.

Subsequently, the HD second audio #n+2 stored in the audio buffer 53A is read out at the timing offering AV synchronization with the outputting (displaying) of the HD video #n+2, which is stored in the video buffer 53V and associated with the HD second audio #n+2, so that the read-out HD second audio #n+2 is supplied to the decoder 54 at the subsequent stage.

Therefore, if a user carries out operation to switch the audio output from the HD first audio to the HD second audio at the timing of reading-out of the HD first audio #n from the audio buffer 53A, the buffer flush of the audio buffer 53A is carried out although buffer flush of the video buffer 53V is not carried out and hence HD video is continuously output. Thus, in the buffer flush, the HD audio (HD first audio) #n and #n+1 associated with the HD video #n and #n+1 stored in the video buffer 53V are discarded. As a result, a silent state continues during the outputting of the HD video #n and #n+1. That is, the silent state arises only for a short time.

Thereafter, the outputting of the HD audio (HD second audio #n+2) is restarted at the timing of outputting of the HD video #n+2 associated with the HD second audio #n+2, which is the earliest data stored in the audio buffer 53A after the buffer flush.

Due to the above-described feature that each of the buffer sizes of the video buffer 53V and the audio buffer 53A is dynamically changed to a buffer size appropriate for temporal storing of an ES supplied from the demultiplexer 52, the continuation of a silent state for a long time at the time of the buffer flush of the audio buffer 53A as one of the video buffer 53V and the audio buffer 53A can be prevented without providing groups of plural buffers equivalent to the video buffer 53V and the audio buffer 53A, respectively, i.e., without increase in the cost of the TV.

Similarly, also at the time of buffer flush of the video buffer 53V as the other of the video buffer 53V and the audio buffer 53A, the continuation of a blank state for a long time can be prevented. Specifically, for example, if an MPEG stream includes a first kind of video stream and a second kind of video stream as video streams and the video output is switched from one of the first and second kinds of video stream to the other in response to user's operation or the like, buffer flush of the video buffer 53V needs to be carried out. However, also at the time of the buffer flush of the video buffer 53V, the continuation of a blank state for a long time can be prevented.

As described above, the controller 56 dynamically controls each of the buffer sizes of the video buffer 53V and the audio buffer 53A to a buffer size appropriate for temporal storing of an ES supplied from the demultiplexer 52. In this buffer size control by the controller 56, each of the buffer sizes of the video buffer 53V and the audio buffer 53A may be actually changed by changing each of the sizes of the storage areas that are ensured as the video buffer 53V and the audio buffer 53A from the storage area of the memory as hardware for example. Alternatively, each of the buffer sizes of the video buffer 53V and the audio buffer 53A can be so-called substantially (virtually) changed by the following scheme. Specifically, the sizes of the storage areas in the memory ensured as the video buffer 53V and the audio buffer 53A are not changed, but each of threshold values for preventing overflow from the video buffer 53V and the audio buffer 53A (hereinafter, referred to as overflow thresholds) is controlled.

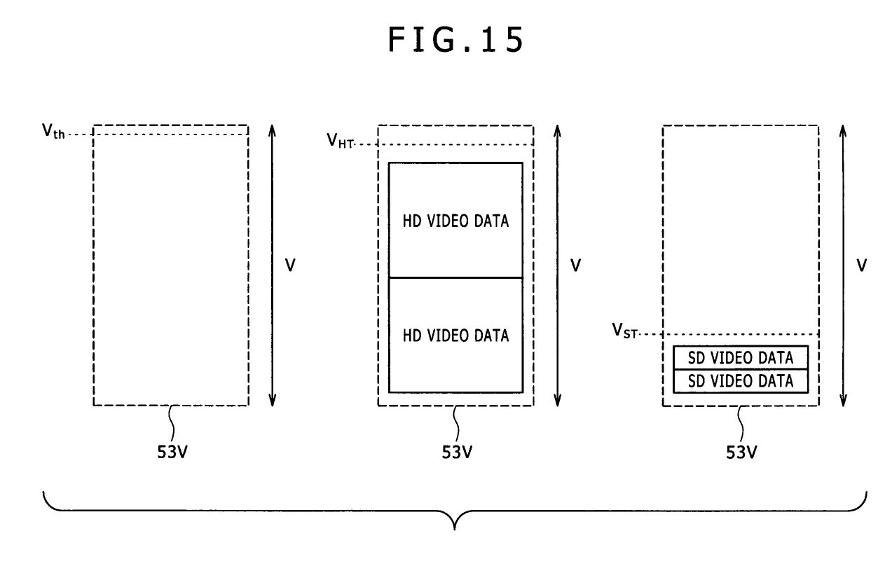

FIG. 15 is a diagram for explaining the feature that the buffer size of the video buffer 53V is substantially changed through control of the overflow threshold.

The leftmost diagram of FIG. 15 shows the video buffer 53V having a fixed buffer size V.

If a value Vₜₕ at a predetermined ratio to the buffer size V is employed as the threshold value (overflow threshold) TH for preventing overflow from the video buffer 53V having the buffer size V, the video decoder 54V reads out data from the video buffer 53V in such a way that the data amount (accumulation amount) of the data stored in the video buffer 53V does not surpass the value Vₜₕ as the overflow threshold TH, if possible. Furthermore, the demultiplexer 52 writes data to the video buffer 53V in such a way that the accumulation amount of the video buffer 53V does not surpass the value Vₜₕ as the overflow threshold TH, if possible.

In this case, after the buffer size setting unit 61 in the controller 56 (FIG. 10) sets the buffer size V_{S} of the video buffer 53V appropriate for storing of SD video or the buffer size V_{H} of the video buffer 53V appropriate for storing of HD video, the buffer controller 62 sets the overflow threshold TH of the video buffer 53V to e.g. a value at a predetermined ratio to the appropriate buffer size V_{S} or V_{H} as the value corresponding to the appropriate buffer size V_{S} or V_{H}. This allows the buffer size of the video buffer 53V to be controlled to the appropriate buffer size V_{S} or V_{H} substantially.

Specifically, the middle diagram of FIG. 15 shows the video buffer 53V whose overflow threshold TH is set to a value V_{HT} corresponding to the buffer size V_{H} appropriate for HD video.

In this case, the video decoder 54V reads out data from the video buffer 53V in such a way that the accumulation amount of the video buffer 53V does not surpass the value V_{HT} as the overflow threshold TH, if possible. Furthermore, the demultiplexer 52 writes data to the video buffer 53V in such a way that the accumulation amount of the video buffer 53V does not surpass the value V_{HT} as the overflow threshold TH, if possible. As a result, the buffer size of the video buffer 53V is set to the buffer size V_{H} appropriate for HD video substantially.

Specifically, the rightmost diagram of FIG. 15 shows the video buffer 53V whose overflow threshold TH is set to a value V_{ST} corresponding to the buffer size V_{S} appropriate for SD video.

In this case, the video decoder 54V reads out data from the video buffer 53V in such a way that the accumulation amount of the video buffer 53V does not surpass the value V_{ST} as the overflow threshold TH, if possible. Furthermore, the demultiplexer 52 writes data to the video buffer 53V in such a way that the accumulation amount of the video buffer 53V does not surpass the value V_{ST} as the overflow threshold TH, if possible. As a result, the buffer size of the video buffer 53V is set to the buffer size V_{S} appropriate for SD video substantially.

Also for the audio buffer 53A, the buffer size thereof can be substantially controlled by setting the overflow threshold, similarly to the video buffer 53V.

If the video buffer 53V is turned to the overflow state in which the accumulation amount thereof surpasses the overflow threshold TH, it is possible to carry out buffer flush to discard the data (video stream) stored in the video buffer 53V in the overflow state and thereafter store a video stream newly supplied from the demultiplexer 52. This also applies to the audio buffer 53A.

However, if the video buffer 53V is turned to the overflow state immediately after the change of the overflow threshold TH from a large value to a small value, the above-described data discarding for eliminating the overflow is limited.

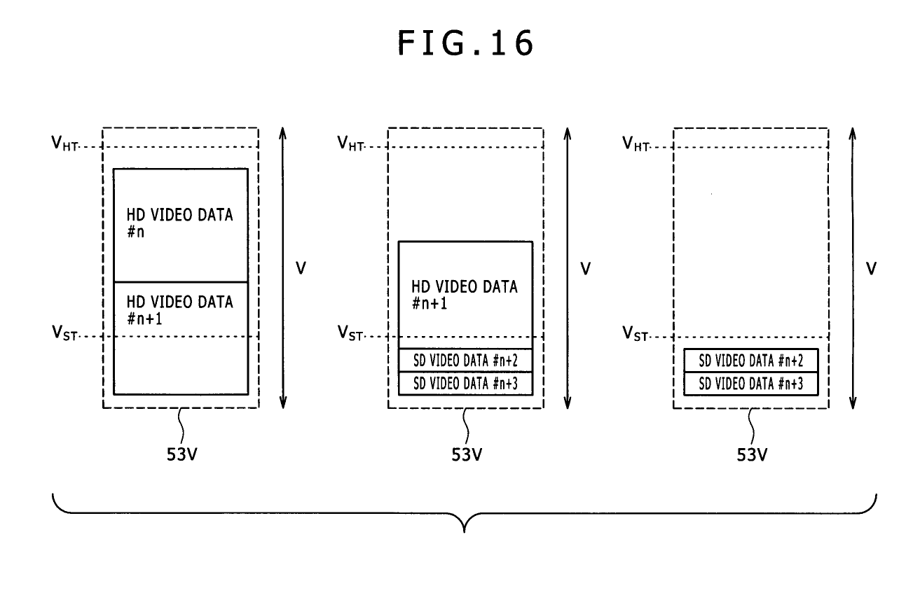

Specifically, FIG. 16 shows the video buffer 53V when the overflow threshold TH is changed from a large value to a small value.

In the leftmost diagram of FIG. 16, the n-th HD video #n and the n+1-th HD video #n+1 are stored in the video buffer 53V, and the accumulation amount of the video buffer 53V is smaller than the overflow threshold V_{HT} for HD video.

The HD video #n and #n+1 stored in the video buffer 53V are sequentially read out so as to be supplied to the decoder 54 at the subsequent stage.

If the video subsequent to the n+1-th HD video #n+1 is SD video, SD video #n+2 is supplied as the n+2-th video and SD video #n+3 is supplied as the n+3-th video from the demultiplexer 52 to the video buffer 53V. From then on, SD video is supplied from the demultiplexer 52 to the video buffer 53V similarly.

Upon the start of the supply of SD video from the demultiplexer 52 to the video buffer 53V, the overflow threshold TH of the video buffer 53V is changed from the overflow threshold V_{HT} for HD video to the overflow threshold V_{ST} for SD video.

The middle diagram of FIG. 16 shows the video buffer 53V in which the n+1-th HD video #n+1, the n+2-th SD video #n+2, and the n+3-th SD video #n+3 are stored after the start of the supply of SD video from the demultiplexer 52 to the video buffer 53V.

In the middle diagram of FIG. 16, because the overflow threshold TH of the video buffer 53V has been changed from the overflow threshold V_{HT} for HD video as a large value to the overflow threshold V_{ST} for SD video as a small value as described above, the accumulation amount of the video buffer 53V in which the HD video #n+1 and the SD video #n+2 and #n+3 are stored surpasses the overflow threshold V_{ST}, and hence the video buffer 53V is in the overflow state.

In this case, if the HD video #n+1 and the SD video #n+2 and #n+3 stored in the video buffer 53V in the overflow state are discarded, video is interrupted.

To avoid this problem, if the video buffer 53V is turned to the overflow state immediately after the change of the overflow threshold TH from a large value to a small value, the data discarding for eliminating the overflow is limited.

The rightmost diagram of FIG. 16 shows the video buffer 53V immediately after the n+1-th HD video #n+1 is read out to the decoder 54.

In the rightmost diagram of FIG. 16, only the SD video #n+2 and #n+3 are stored due to the reading-out of the HD video #n+1 from the video buffer 53V shown in the middle diagram of FIG. 16. As a result, the accumulation amount becomes smaller than the overflow threshold V_{ST}, so that the overflow state is eliminated.

If the overflow threshold TH of the video buffer 53V is changed from the overflow threshold V_{HT} for HD video as a large value to the overflow threshold V_{ST} for SD video as a small value and the video buffer 53V is turned to the overflow state due to this change, the data discarding for eliminating the overflow is limited until the accumulation amount of the video buffer 53V becomes smaller than the overflow threshold V_{ST} for SD video due to reading-out of video from the video buffer 53V and hence the overflow state of the video buffer 53V is eliminated, as described above.

After the accumulation amount of the video buffer 53V becomes smaller than the overflow threshold V_{ST} for SD video and hence the overflow state of the video buffer 53V is eliminated, the video decoder 54V reads out data from the video buffer 53V in such a way that the accumulation amount of the video buffer 53V does not surpass the overflow threshold V_{ST} for SD video, if possible. Furthermore, the demultiplexer 52 writes data to the video buffer 53V in such a way that the accumulation amount of the video buffer 53V does not surpass the overflow threshold V_{ST} for SD video, if possible.

The video buffer 53V can be realized by e.g. a ring buffer.

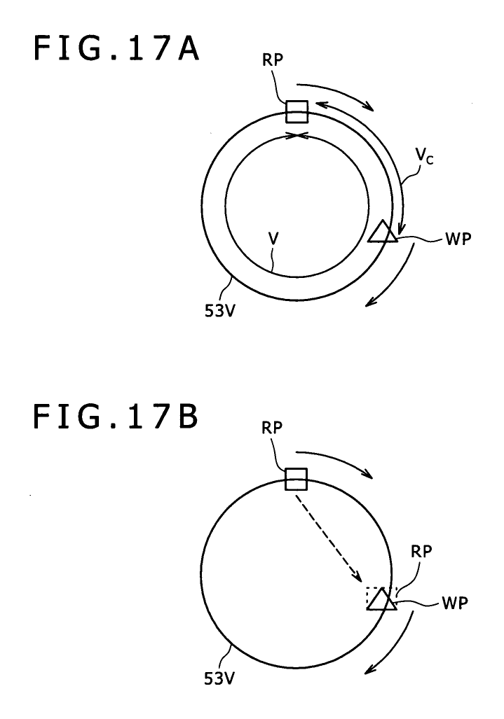

Specifically, FIGS. 17A and 17B schematically show a configuration example of the video buffer 53V formed of a ring buffer.

In FIGS. 17A and 17B, the circumference indicates the storage area of the video buffer 53V as a ring buffer.

Furthermore, in FIGS. 17A and 17B, a read point RP represented by the square on the circumference indicates the position (address) of reading-out of data from the video buffer 53V, and a write point WP represented by the triangle on the circumference indicates the position (address) of writing of data to the video buffer 53V.

If the read point RP and the write point WP rotate on the circumference of FIGS. 17A and 17B in a clockwise manner and data is read out from the position of the read point RP and written to the position of the write point WP, the read point RP and the write point WP are so controlled that one of these points does not overtake the other.

The data amount V_{C} corresponding to the circular arc that runs from the read point RP to the write point WP in a clockwise direction is equivalent to the accumulation amount of the video buffer 53V. The data reading-out from the video buffer 53V and the data writing to the video buffer 53V are so controlled that this accumulation amount does not surpass the overflow threshold TH.

Discarding of the data stored in the video buffer 53V (buffer flush of the video buffer 53V) can be carried out through matching of the position of the write point WP with that of the read point RP, such as moving of the position of the read point RP to that of the write point WP, shown in the diagram of FIG. 17B.

A further detailed description will be made below about the buffer sizes of the video buffer 53V and the audio buffer 53A and the control of the buffer sizes of the video buffer 53V and the audio buffer 53A by the controller 56.

The maximum buffer sizes of the video buffer 53V and the audio buffer 53A are determined based on the data amounts of the video and audio each having the largest data amount among the video and audio that are contemplated to be treated by a TV.

Based on the assumption that the video and audio of currently-available digital broadcasting have the largest data amounts, it is desirable to employ 1.5 megabytes (MB) as the buffer size of the video buffer 53V and employ 128 kilobytes (KB) as the buffer size of the audio buffer 53A, according to experience of the present inventor.

If the values subsequent to 0x indicate hexadecimal numbers, and 1 KB and 1 MB are 1024 bytes (B) and 1024 KB, respectively, 1.5 MB can be represented as 0x180000B in hexadecimal and 128 KB can be represented as 0x20000B in hexadecimal.

The following description is based on the assumption that the buffer sizes of the video buffer 53V and the audio buffer 53A are substantially changed by controlling the overflow thresholds as described with FIG. 15 without changing the buffer sizes themselves of the video buffer 53V and the audio buffer 53A. In the controller 56, the overflow thresholds can be obtained from information on a sequence header and so on through calculation, or alternatively can be obtained through reference to a table that is created in advance and associates the information on a sequence header and so on with the overflow thresholds.

Based on a sequence header and so on, the controller 56 sets the following values as the overflow thresholds of the video buffer 53V and the audio buffer 53A.

Specifically, for example, if the video size indicated in the sequence header, i.e., the number of horizontal×vertical pixels of the video known from horizontal_size_value and vertical_size_value in the sequence header (Sequence_Header), is equal to or larger than the size of 1920×1080 pixels (the video size is equal to or larger than the so-called Full-HD size), the overflow threshold of the video buffer 53V is set to e.g. about 1.2 MB (=0x130000B).

Furthermore, for example, if the video size indicated in the sequence header is equal to or smaller than the size of 352×240 pixels and is equal to or smaller than 64 KB in calculation, the overflow threshold of the video buffer 53V is set to e.g. about 64 KB (=0x10000B).

In addition, for example, if the sampling frequency, bit rate, and codec of the audio data indicated in the sequence header are 48 kHz, 192 kbps, and advanced audio coding (AAC), respectively, the overflow threshold of the audio buffer 53A is set to e.g. about 123 KB (=0x1ec00B).

Subsequently, in the controller 56, the buffer size of the video buffer 53V appropriate for the video as the reproduction subject (the subject to be treated by the TV) can be obtained based on the sequence header and other pieces of the necessary information in the following manner for example.

The present example is based on the assumption that an MPEG stream as the reproduction subject is a pull stream and is stored in a file.

Furthermore, in the present example, the format information that can be acquired from a server, an Info file, and so on when the file storing the reproduction-subject MPEG stream is selected is represented as A. Moreover, as information that can be acquired from sequence header and picture header of the MPEG stream, there are the video size, the bit rate, the VBV buffer size (VBV_Buffer_Size), the profile (Profile), the level (Level), and information on whether or not the video codec is MPEG1 (hereinafter, referred to as the MPEG1 flag). The video size is represented as B, the bit rate as C, the VBV buffer size as D, the profile and the level as E, and the MPEG1 flag as F.

The MPEG1 flag F is set through a determination as to whether or not the video codec is MPEG1 based on plural values such as the full_pel_forward_vector value.

In addition, the maximum size of the VBV buffer (the maximum VBV size) dependent upon the profile of MPEG2 is represented as G, and the time during which data can be stored in the video buffer 53V (allowed time) is represented as H [milliseconds].

The allowed time H is determined based on the empirical rule.

The controller 56 checks the matching of the profile and the format, and so on based on the format information A, the profile and the level E, and the MPEG1 flag F, and selects a “table” allocated on a profile-by-profile basis.

What to select as the “table” when the profile is unmatched has been derived from the past trend and so on. Although the profile is not defined for MPEG1, a virtual profile is allocated thereto based on the empirical rule. The profile selected at this time is represented as I.

Subsequently, the controller 56 selects the appropriate video buffer size J from the table based on the video size B. The “table” is created in advance based on the MPEG standard and the empirical rule.

Thereafter, the controller 56 derives the expected buffer amount tmp1 based on the bit rate C and the allowed time H, e.g. in accordance with the equation tmp1=C×H.

Furthermore, because the obtained bit rate C is not necessarily correct, the controller 56 corrects the buffer amount tmp1 to thereby obtain a new buffer amount tmp1′

Specifically, when the buffer amount tmp1 is larger than the maximum VBV size G defined by the profile I, the controller 56 employs the maximum VBV size G as the new buffer amount tmp1′ (tmp1′=G). When the buffer amount tmp1 is not larger than the maximum VBV size G defined by the profile I, the controller 56 employs the buffer amount tmp1 directly as the new buffer amount tmp1′ (tmp1′=tmp1=C×H).

In addition, because the obtained bit rate C is not necessarily correct, the controller 56 corrects the VBV buffer size D to thereby obtain a new VBV buffer size tmp2.

Specifically, when the VBV buffer size D is larger than the maximum VBV size G defined by the profile I, the controller 56 employs the maximum VBV size G as the new VBV buffer size tmp2 (tmp2=G). When the VBV buffer size D is not larger than the maximum VBV size G defined by the profile I, the controller 56 employs the VBV buffer size D directly as the new VBV buffer size tmp2 (tmp2=D).

Subsequently, the controller 56 obtains the buffer size tmp of the video buffer 53V appropriate for the reproduction-subject video e.g. in accordance with the equation tmp=(α×J+β×tmp1′+γ×tmp2)/3.

The coefficients α, β, and γ are weighting factors that are obtained in advance based on the empirical rule.

If the buffer size tmp is too small, there is the possibility that the TV does not operate correctly. Therefore, when the buffer size tmp is smaller than the predetermined minimum value MIN, the controller 56 corrects the buffer size tmp to the minimum value MIN (tmp=MIN).

This minimum value MIN depends on the value defined by the MPEG2 profile and so on. For MPEG1, a very small value would be calculated as the minimum value MIN because the profile is absent. In practice, the minimum value MIN is determined in consideration of restrictions on integrated circuits (IC) used in the TV, and so on.

Moreover, in the controller 56, the buffer size of the audio buffer 53A appropriate for the reproduction-subject audio can be obtained based on various kinds of headers included in the MPEG stream and other pieces of the necessary information in the following manner for example.

The present example is based on the assumption that an MPEG stream as the reproduction subject is a pull stream and is stored in a file.

Furthermore, in the present example, information on the codec (codec information) that can be acquired from a server, an Info file, and so on when the file storing the reproduction-subject MPEG stream is selected is represented as A.

Moreover, as information that can be acquired from a header of the MPEG stream, there are the codec information, the bit rate, and the sampling frequency. The codec information, the bit rate, and the sampling frequency are represented as B, C, and D, respectively.

In addition, the time during which data can be stored in the audio buffer 53A (allowed time) is represented as E [milliseconds].

The allowed time E is determined based on the empirical rule.

The controller 56 checks the matching of the codec from the codec information A and B, and selects a reference buffer amount K allocated on a codec-by-codec basis.

A table of the reference buffer amount K is created in advance inside the controller 56, and the corresponding buffer amount K is selected from the table. What to select as the reference buffer amount K when the codec is unmatched has been derived from the past trend and so on, and this amount can be selected from the table.

Subsequently, the controller 56 obtains a ratio factor α from the sampling frequency D.

Furthermore, the controller 56 obtains the buffer size tmp of the audio buffer 53A appropriate for the reproduction-subject audio e.g. in accordance with the equation tmp=α×C×K.

There is the possibility that the information that can be acquired from the header of the MPEG stream is incorrect. Therefore, when the buffer size tmp is smaller than the predetermined minimum value MIN, the controller 56 corrects the buffer size tmp to the minimum value MIN (tmp=MIN). When the buffer size tmp is larger than the predetermined maximum value MAX, the controller 56 corrects the buffer size tmp to the maximum value MAX (tmp=MAX).

The maximum value MAX is determined depending on e.g. the memory size and the codec information. The minimum value MIN is determined in consideration of e.g. the smallest sample necessary for the decoding, which can be calculated from the codec information, and restrictions on ICs used in the TV.

For example, apparatus such as a TV for processing a push MPEG stream sent by digital broadcasting or the like is required to process an MPEG stream of a moving picture captured by a digital still camera, HD digital video camera (HD-CAM), or the like and a pull MPEG stream from a device that outputs the pull MPEG stream and functions as a DLNA (Digital Living Network Alliance) server, such as a recorder typified by Sugoroku (trademark) or a PC typified by Vaio (trademark), by using a decoder for decoding a push MPEG stream and a memory area in which a push MPEG stream is temporarily stored.

This is because the cost, substrate area, and power consumption are increased if decoder and memory area for processing a pull MPEG stream are provided separately from the decoder and memory area for processing a push MPEG stream.

However, the following problem is possibly caused if a pull MPEG stream is processed by using the decoder and memory area for processing a push MPEG stream and the pull MPEG stream includes elementary streams of plural kinds of video (e.g., SD video and HD video), elementary streams of plural kinds of audio (e.g., Japanese audio and English audio), or elementary streams of plural kinds of caption (e.g., Japanese caption and English caption). Specifically, when the elementary-stream output is switched from a certain kind of elementary stream to another kind of elementary stream, more specifically when audio is switched from Japanese to English in reproduction of a DVD for example, buffer flush of an ES (Elementary Stream) buffer as the memory area for storing the elementary stream needs to be carried out for the switching.

If the buffer flush of the ES buffer is carried out, it takes a long time until outputting of the elementary stream after the switching is started depending on the buffer size of the ES buffer as described above with FIG. 7. This will cause a user to feel a sense of discomfort.

To address this problem, when a pull MPEG stream is processed by using the decoder and memory area for processing a push MPEG stream, the buffer sizes (overflow thresholds) of the ES buffers (e.g., the video buffer 53V and the audio buffer 53A of FIG. 10) are changed between sizes employed in processing of a push MPEG stream and sizes employed in processing of a pull MPEG stream. This can shorten the time until outputting of e.g. video after switching is started after buffer flush is carried out to switch the video output in processing of a pull MPEG stream such as an MPEG stream reproduced from a DVD.

Specifically, in processing of a pull MPEG stream, the buffer size of the ES buffer is set smaller than that in processing of a push MPEG stream. This decreases the data amount of e.g. video discarded at the time of buffer flush, which results in the shortening of the time until outputting of video after the switching is started.

When the TV of FIG. 9 treats an MPEG stream stored in a file as the reproduction subject, various kinds of information on the file can be recognized when the file storing the MPEG stream as the reproduction subject is selected in many cases (the information can be acquired from an Info file and a server). Therefore, based on the information, the buffer sizes (overflow thresholds) of the video buffer 53V and the audio buffer 53A as ES buffers can be changed.

For example, when the reproduction-subject MPEG stream stored in a file is recognized as an MPEG2-TS, the MPEG stream includes HD content in many cases because the possibility that an MPEG-TS is a stream of content captured by an HD-CAM or a stream of content sent by digital broadcasting is high. Therefore, when the reproduction-subject MPEG stream is an MPEG2-TS, the buffer size of the video buffer 53V in the TV can be changed to e.g. about 1.2 MB, which is a large value appropriate for HD content.

Furthermore, when the reproduction-subject MPEG stream stored in a file is recognized as an MPEG2-PS (Program Stream) for example, the possibility that the MPEG stream is a stream of SD content, such as a stream of content recorded in a DVD, is high. Therefore, when the reproduction-subject MPEG stream is an MPEG2-PS, the buffer size of the video buffer 53V in the TV can be changed to e.g. about 256 KB, which is a small value appropriate for SD content.

Moreover, when the reproduction-subject MPEG stream stored in a file is recognized as an MPEG1 system stream for example, there is the possibility that the MPEG stream needs up to the same buffer size as that in processing of an MPEG2-PS of SD content. Therefore, when the reproduction-subject MPEG stream is an MPEG1 system stream, the buffer size of the video buffer 53V in the TV can be changed to e.g. about 256 KB, which is appropriate for SD content as described above.

In addition, in the TV of FIG. 9, the buffer size of the audio buffer 53A can be changed based on the codec for an audio stream supplied from the demultiplexer 52 to the audio buffer 53A.

For example, the buffer size of the audio buffer 53A can be changed to about 128 KB when the codec for an audio stream is AAC, to about 32 KB when it is MPEG-Audio, to about 64 KB when it is LPCM (Linear Pulse-Code Modulation), and to about 64 KB when it is AC3 (Audio Code number 3).

If the buffer sizes of the video buffer 53V and the audio buffer 53A are controlled based on only the information that can be recognized when the file storing an MPEG stream as the reproduction subject is selected, it is difficult for the TV to treat an MPEG stream whose codec, video size, and HD/SD are changed in the middle of the file.

To address this problem, the buffer sizes of the video buffer 53V and the audio buffer 53A are dynamically controlled also based on headers such as a sequence header included in the reproduction-subject MPEG stream. This allows the buffer sizes of the video buffer 53V and the audio buffer 53A to be changed to appropriate buffer sizes for an MPEG stream whose codec and other factors are changed in the middle.

As described above, in the TV of FIG. 9, the necessary ES is separated from an MPEG stream and temporarily stored, and the buffer size of the video buffer 53V is dynamically controlled based on profile information, video size, VBV buffer size, bit rate, and so on included in a sequence header and so forth obtained in the middle of decoding processing. Due to this feature, when buffer flush of one of the video buffer 53V and the audio buffer 53A is carried out, video and audio with AV synchronization can be rapidly output after a short blank or silent time.

Furthermore, in the TV of FIG. 9, only one video buffer 53V is provided as an ES buffer in which a video stream is stored. Therefore, the cost can be reduced compared with a TV in which an ES buffer is provided for each of kinds of video, such as a TV provided with both an ES buffer in which a video stream of SD video is stored and an ES buffer in which a video stream of HD video is stored.

If the demultiplexer 52, the memory 53, the decoder 54, the external output 55, and the controller 56 in the TV of FIG. 9 are referred to collectively as a stream processor, the TV of FIG. 9 can process e.g. HD content and SD content by a single stream processor, and therefore a memory, CPU, and so on therein can be reduced compared with a TV in which a stream processor for processing HD content and a stream processor for processing SD content are provided separately from each other. As a result, the cost can be reduced.

Furthermore, the substrate area can be decreased, which allows miniaturization of the device.

In addition, the power consumption can be reduced.

Moreover, e.g. an MPEG stream including mixture of HD content and SD content can be smoothly reproduced, which can pervert a user from feeling a sense of discomfort.

Furthermore, in the case in which an MPEG stream includes first and second kinds of audio stream, it is possible to shorten a silent time arising due to buffer flush of the audio buffer 53A and the time until outputting of video and audio with AV synchronization is started when the audio output is switched from one of the first and second kinds of audio stream to the other in response to user's operation. Similarly, in the case in which an MPEG stream includes first and second kinds of video stream, it is possible to shorten a blank time arising due to buffer flush of the video buffer 53V and the time until outputting of video and audio with AV synchronization is started when the video output is switched from one of the first and second kinds of video stream to the other in response to user's operation.

As a result, it is possible to prevent a user from feeling a sense of discomfort due to a long silent time, a long blank time, and a long time until outputting of video and audio with AV synchronization is started.

As for the audio buffer 53A, based on the codec (coding method (system)) for an audio stream supplied from the demultiplexer 52 to the audio buffer 53A, the buffer size can be controlled to a buffer size appropriate for an audio stream of the codec.

By controlling both the buffer sizes of the video buffer 53V and the audio buffer 53A to appropriate buffer sizes, the time until outputting of video and audio with AV synchronization is started when buffer flush of both the video buffer 53V and the audio buffer 53A is carried out can be shortened. This can prevent a user from feeling a sense of discomfort due to a long time until outputting of video and audio with AV synchronization is started.

Moreover, e.g. a push MPEG stream such as an MPEG stream sent by digital broadcasting or the like and a pull MPEG stream such as an MPEG stream of a moving picture captured by a digital camera can be processed by a single stream processor, which can reduce the cost.

Although the embodiment of the present invention is applied to a TV in the above description, the embodiment can also be applied to other devices such as a player for reproducing content.

Furthermore, the bit stream as the processing subject is not limited to an MPEG stream. In addition, it is also possible that the memory 53 be further provided with an ES buffer in which an ES of data other than video and audio (e.g., an ES of a caption) is stored and the buffer size of this ES buffer is controlled to an appropriate buffer size in the TV similarly to the video buffer 53V and the audio buffer 53A.

It should be noted that in the present specification, the processing steps that describe a program for causing a computer (e.g., the CPU 57 of FIG. 9) to execute various kinds of processing do not necessarily need to be carried out in a time-series manner along the order described as the flowchart but also encompass processing executed in parallel or individually (e.g., parallel processing or processing by an object).

A program may be processed by one computer, or alternatively may be processed by plural computers by distributed processing.

It should be noted that embodiments of the present invention are not limited to the above-described embodiment but various modifications might be incorporated therein without departing from the scope and spirit of the present invention.

What is claimed is:

1. A data processing device that processes a bit stream including at least first data and second data, the device comprising:
buffer size setting means for setting, of a first buffer size of a first buffer and a second buffer size of a second buffer, the first buffer size based on information included in the bit stream, the first buffer temporarily storing the first data and supplying the first data to a first decoder, the second buffer temporarily storing the second data and supplying the second data to a second decoder; and
buffer controlling means for controlling a buffer size of the first buffer to the first buffer size.

2. The data processing device according to claim 1, wherein
the buffer size setting means sets the second buffer size based on information included in the bit stream, and the buffer controlling means controls a buffer size of the second buffer to the second buffer size.

3. The data processing device according to claim 2, wherein
the buffer controlling means sets a threshold for preventing overflow from the first buffer to a value corresponding to the first buffer size to thereby control the buffer size of the first buffer to the first buffer size, and sets a threshold for preventing overflow from the second buffer to a value corresponding to the second buffer size to thereby control the buffer size of the second buffer to the second buffer size.

4. The data processing device according to claim 2, wherein
the bit stream is an MPEG, which stands for Moving Picture Experts Group, stream compliant with a standard of MPEG,
the first data is video data,
the second data is audio data, and
the buffer size setting means sets the first buffer size based on information on a sequence header and sets the second buffer size based on information on a codec.

5. The data processing device according to claim 4, wherein
the MPEG stream includes a first kind of video data and a second kind of video data as the first data, and
the first buffer is cleared at the time of switching of output from one of the first kind of video data and the second kind of video data to the other in response to operation of a user.

6. The data processing device according to claim 4, wherein
the MPEG stream includes a first kind of audio data and a second kind of audio data as the second data, and
the second buffer is cleared at the time of switching of output from one of the first kind of audio data and the second kind of audio data to the other in response to operation of a user.

7. A data processing method for processing a bit stream including at least first data and second data, the method comprising the steps of:
setting, of a first buffer size of a first buffer and a second buffer size of a second buffer, the first buffer size based on information included in the bit stream, the first buffer temporarily storing the first data and supplying the first data to a first decoder, the second buffer temporarily storing the second data and supplying the second data to a second decoder; and
controlling a buffer size of the first buffer to the first buffer size.

8. A program for causing a computer to function as a data processing device that processes a bit stream including at least first data and second data, the device comprising:
buffer size setting means for setting, of a first buffer size of a first buffer and a second buffer size of a second buffer, the first buffer size based on information included in the bit stream, the first buffer temporarily storing the first data and supplying the first data to a first decoder, the second buffer temporarily storing the second data and supplying the second data to a second decoder; and
buffer controlling means for controlling a buffer size of the first buffer to the first buffer size.

9. A data processing device that processes a bit stream including at least first data and second data, the device comprising:
a buffer size setting unit configured to set, of a first buffer size of a first buffer and a second buffer size of a second buffer, the first buffer size based on information included in the bit stream, the first buffer temporarily storing the first data and supplying the first data to a first decoder, the second buffer temporarily storing the second data and supplying the second data to a second decoder; and
a buffer controller configured to control a buffer size of the first buffer to the first buffer size.
